(19) United States
(12) Patent Application Publication
(10) Pub. No.: US 2012/0007804 A1
(43) Pub. Date: Jan. 12, 2012

(54) INTERACTIVE INPUT SYSTEM AND METHOD

(75) Inventors: Gerald D. Morrison, Calgary (CA); Daniel Peter McReynolds, Calgary (CA); Alex Chtchetinine, Calgary (CA); Grant Howard McGibney, Calgary (CA); David E. Holmgren, Calgary (CA); Ye Zhou, Calgary (CA); Brinda Kabada, Calgary (CA); Sameh Al-Eryani, Calgary (CA)

(73) Assignee: SMART Technologies ULC, Calgary (CA)

(21) Appl. No.: 12/834,734

(22) Filed: Jul. 12, 2010

(51) Int. Cl. G09G 5/08

(52) U.S. Cl. 345/158

(57) ABSTRACT

A method of resolving ambiguities between at least two pointers within a region of interest comprises capturing images of the region of interest and at least one reflection thereof from different vantages using a plurality of imaging devices, processing image data to identify a plurality of targets for the at least two pointers, for each image, determining a state for each target and assigning a weight to the image data based on the state, and calculating a pointer location for each of the at least two pointers based on the weighted image data.

### FIELD OF THE INVENTION

The present invention relates generally to input systems and in particular to a multiple input interactive input system and method of resolving pointer ambiguities.

### BACKGROUND OF THE INVENTION

Interactive input systems that allow users to inject input such as for example digital ink, mouse events etc. into an application program using an active pointer (e.g., a pointer that emits light, sound or other signal), a passive pointer (e.g., a finger, cylinder or other object) or other suitable input device such as for example, a mouse or trackball, are well known. These interactive input systems include but are not limited to: touch systems comprising touch panels employing analog resistive or machine vision technology to register pointer input such as those disclosed in U.S. Pat. Nos. 5,448,263; 6,141,000; 6,337,681; 6,747,636; 6,803,906; 7,232,986; 7,236,162; and 7,274,356 and in U.S. Patent Application Publication No. 2004/0179001 assigned to SMART Technologies ULC of Calgary, Alberta, Canada, assignee of the subject application, the contents of which are incorporated by reference in their entireties; touch systems comprising touch panels employing electromagnetic, capacitive, acoustic or other technologies to register pointer input; tablet personal computers (PCs); laptop PCs; personal digital assistants (PDAs); and other similar devices.

Above-incorporated U.S. Pat. No. 6,803,906 to Morrison et al. discloses a touch system that employs machine vision to detect pointer interaction with a touch surface on which a computer-generated image is presented. A rectangular bezel or frame surrounds the touch surface and supports digital cameras at its four corners. The digital cameras have overlapping fields of view that encompass and look generally across the touch surface. The digital cameras acquire images looking across the touch surface from different vantages and generate image data. Image data acquired by the digital cameras is processed by on-board digital signal processors to determine if a pointer exists in the captured image data. When it is determined that a pointer exists in the captured image data, the digital signal processors convey pointer characteristic data to a master controller, which in turn processes the pointer characteristic data to determine the location of the pointer in (x,y) coordinates relative to the touch surface using triangulation. The pointer coordinates are then conveyed to a computer executing one or more application programs. The computer uses the pointer coordinates to update the computer-generated image that is presented on the touch surface. Pointer contacts on the touch surface can therefore be recorded as writing or drawing or used to control execution of application programs executed by the computer.

In environments where the touch surface is small, more often than not, users interact with the touch surface one at a time, typically using a single pointer. In situations where the touch surface is large, as described in U.S. Pat. No. 7,355,593 to Hill et al., issued on Apr. 8, 2008, assigned to SMART Technologies ULC, the content of which is incorporated by reference in its entirety, multiple users may interact with the touch surface simultaneously.

As will be appreciated, in machine vision touch systems, when a single pointer is in the fields of view of multiple imaging devices, the position of the pointer in (x,y) coordinates relative to the touch surface typically can be readily computed using triangulation. Difficulties are however encountered when multiple pointers are in the fields of view of multiple imaging devices as a result of pointer ambiguity and occlusion. Ambiguity arises when multiple pointers in the images captured by the imaging devices cannot be differentiated. In such cases, during triangulation a number of possible positions for the pointers can be computed but no information is available to the touch systems to allow the correct pointer positions to be selected. Occlusion occurs when one pointer occludes another pointer in the field of view of an imaging device. In these instances, the image captured by the imaging device includes only one pointer. As a result, the correct positions of the pointers relative to the touch surface cannot be disambiguated from false pointer positions. As will be appreciated, improvements in multiple input interactive input systems are desired.

It is therefore an object of the present invention to provide a novel interactive input system and method of resolving pointer ambiguities.

### SUMMARY OF THE INVENTION

Accordingly, in one aspect there is provided a method of resolving ambiguities between at least two pointers within a region of interest comprising capturing images of the region of interest and at least one reflection thereof from different vantages using a plurality of imaging devices; processing image data to identify a plurality of targets for the at least two pointers; for each image, determining a state for each target and assigning a weight to the image data based on the state; and calculating a pointer location for each of the at least two pointers based on the weighted image data.

According to another aspect there is provided an interactive input system comprising an input surface divided into at least two input areas; at least one mirror positioned with respect to the input surface and producing a reflection thereof, thereby defining at least two virtual input areas; a plurality of imaging devices having at least partially overlapping fields of view, the imaging devices being oriented so that different sets of imaging devices image the input area and virtual input areas; and processing structure processing image data acquired by the imaging devices to track the position of at least two pointers adjacent the input surface and resolving ambiguities between the pointers.

According to another aspect there is provided an interactive input system comprising a plurality of imaging devices having fields of view encompassing an input area and a virtual input area, the imaging devices being oriented so that different sets of imaging devices image different input regions of the input area and the virtual input area.

### BRIEF DESCRIPTION OF THE DRAWINGS

Embodiments will now be described more fully with reference to the accompanying drawings in which:

FIG. 1 is a perspective view of an interactive input system.

FIG. 2 is another perspective view of the interactive input system of FIG. 1 with its cover removed to expose imaging devices and an illuminated bezel that surround an input area.

FIG. 3 is yet another perspective view of the interactive input system of FIG. 1 with the cover removed.

FIG. 4 is an enlarged perspective view of a portion of the interactive input system of FIG. 1 with the cover removed.

FIG. 5 is a top plan view showing the imaging devices and illuminated bezel that surround the input area.

FIG. 6 is a side elevational view of a portion of the interactive input system of FIG. 1 with the cover removed.

FIG. 7 is a top plan view showing the imaging devices and input regions of the input area.

FIG. 8 is a schematic block diagram of one of the imaging devices.

FIG. 9 is a schematic block diagram of a master controller forming part of the interactive input system of FIG. 1.

FIGS. 10a, 10b and 10c are perspective, top plan and front elevational views, respectively, of a bezel segment forming part of the illuminated bezel.

FIG. 11a is another front elevational view of the bezel segment of FIGS. 10a to 10c better illustrating showing the dimple pattern on the diffusive front surface thereof.

FIGS. 11b and 11c are front elevational views of alternative bezel segments showing dimple patterns on the diffusive front surfaces thereof.

FIG. 12 is a perspective view of a portion of another alternative bezel segment showing the diffusive front surface thereof.

FIG. 13 is a flow chart showing the steps performed during a candidate generation procedure.

FIG. 14 is an observation table built by the candidate generation procedure.

FIG. 15 is a flow chart showing the steps performed during an association procedure.

FIG. 16 shows an example of multiple target tracking.

FIGS. 17 and 18 show two targets within the input area and the weights assigned to the observations associated with the targets.

FIGS. 19 to 24 show multiple target scenarios, determined centerlines for each target observation and the weights assigned to the target observations.

FIG. 25 is a flow chart showing the steps performed during triangulation of real and phantom targets.

FIGS. 26 to 34 show alternative imaging device configurations for the interactive input system of FIG. 1.

FIGS. 35 to 40 show alternative embodiments of bezel segments for the illuminated bezel.

FIG. 41 shows exemplary image frames of the input area showing the three possible states for multiple targets as seen by an imaging device.

FIG. 42 shows another alternative imaging device and illuminated bezel configuration for the interactive input system.

FIG. 43 shows real and virtual input areas of the interactive input system of FIG. 42.

FIG. 44 shows two targets contacting the real input area of the interactive input system of FIG. 42.

FIG. 45 shows the two targets contacting the real and virtual input areas of the interactive input system of FIG. 42.

FIG. 46 is a flow chart showing a modified method for alternative embodiments of the interactive input system.

FIGS. 47 to 50 show further alternative imaging device and illuminated bezel configurations for the interactive input system.

### DETAILED DESCRIPTION OF THE EMBODIMENTS

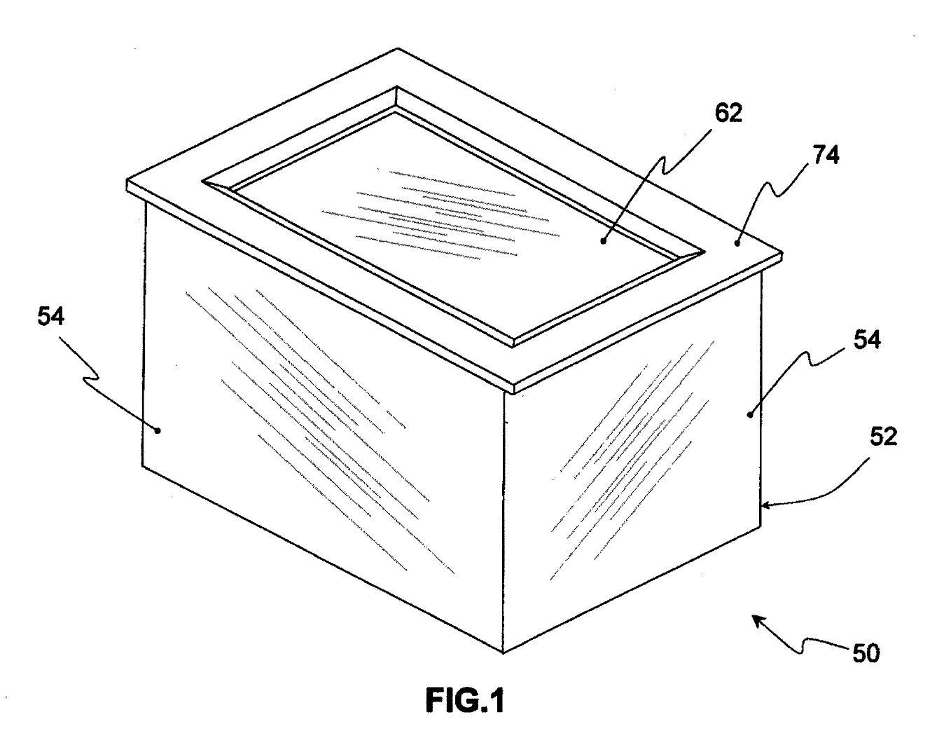

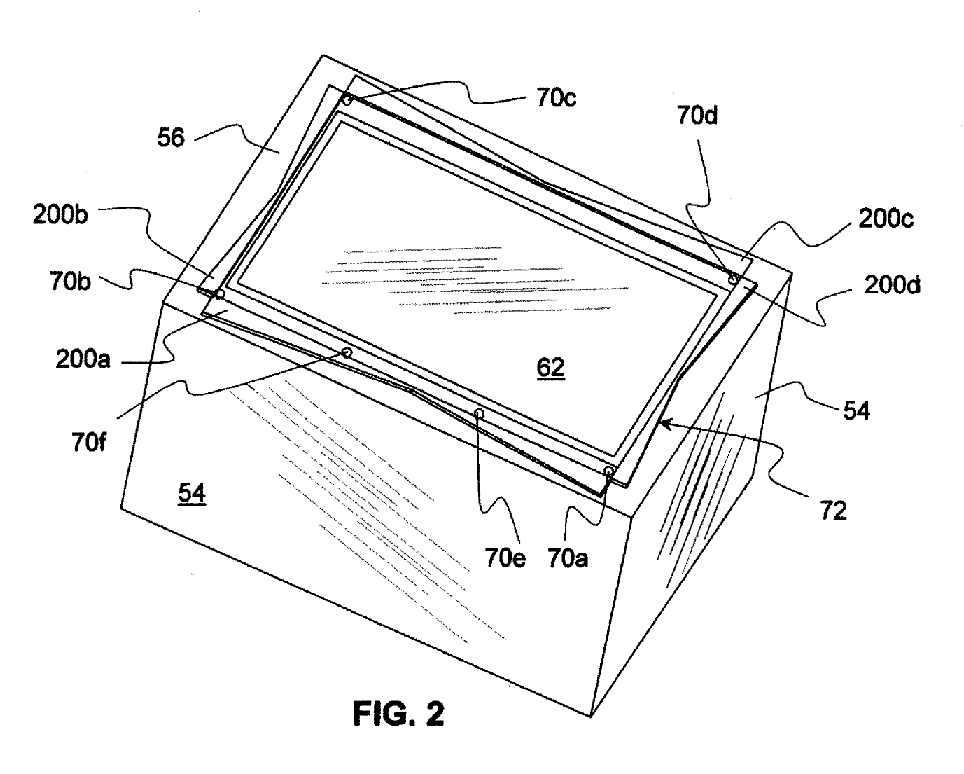

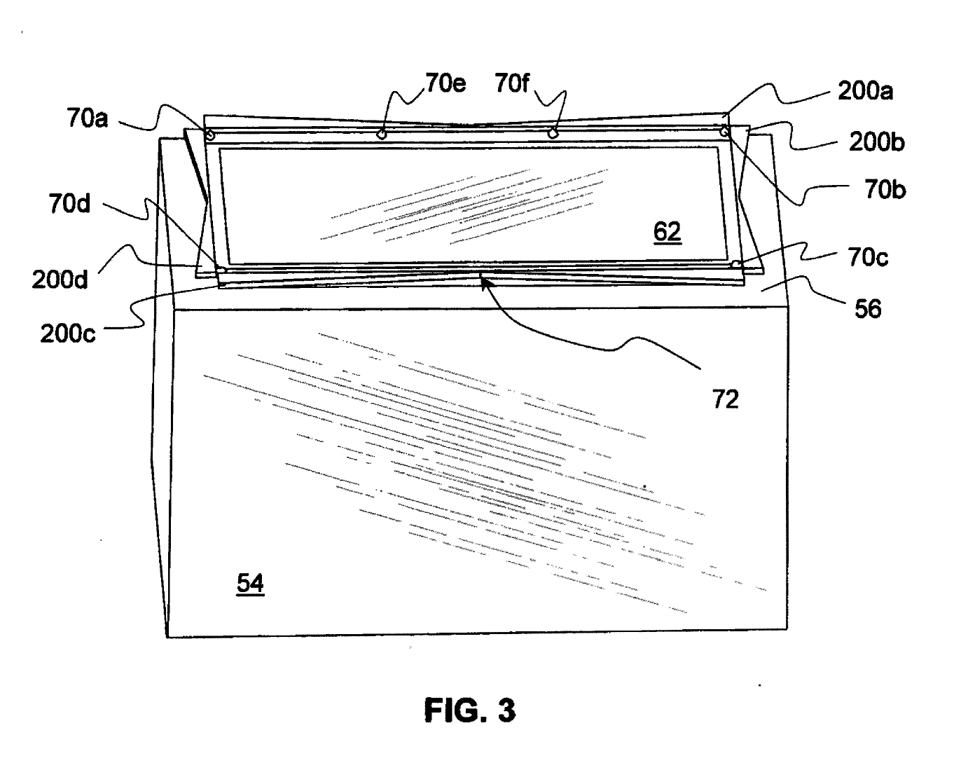

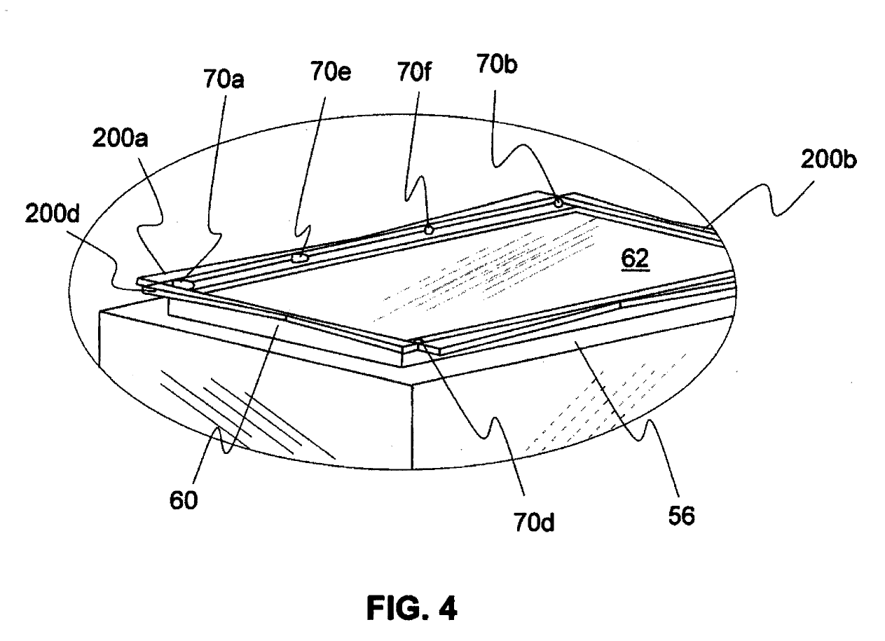

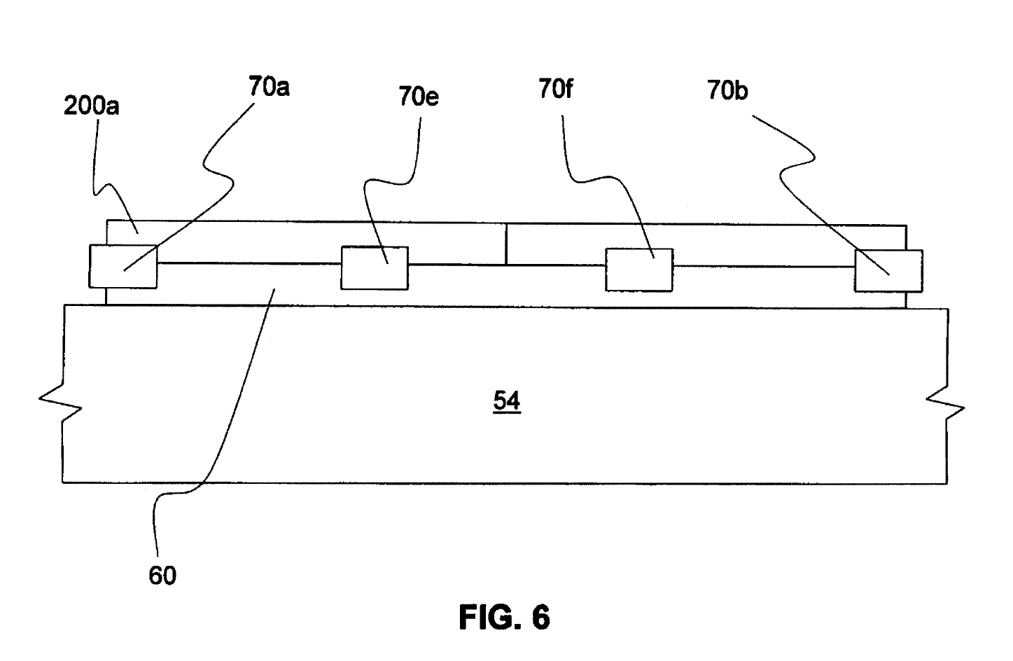

Turning now to FIGS. 1 to 6, an interactive input system is shown and is generally identified by reference numeral 50. In this embodiment, the interactive input system 50 is in the form of a touch table that is capable of detecting and tracking individually eight (8) different pointers or targets brought into proximity of the touch table. As can be seen touch table 50 comprises a generally rectangular box-like housing 52 having upright sidewalls 54 and a top wall 56. A liquid crystal display (LCD) or plasma display panel 60 is centrally positioned on the top wall 56 and has a display surface over which a region of interest or input area 62 is defined. Imaging devices 70a to 70f are mounted on the LCD panel 60 about the input area 62 and look generally across the input area from different vantages. An illuminated bezel 72 surrounds the periphery of the input area 62 and overlies the imaging devices 70a to 70f. The illuminated bezel 72 provides backlight illumination into the input area 62. A cover 74 overlies the illuminated bezel 72.

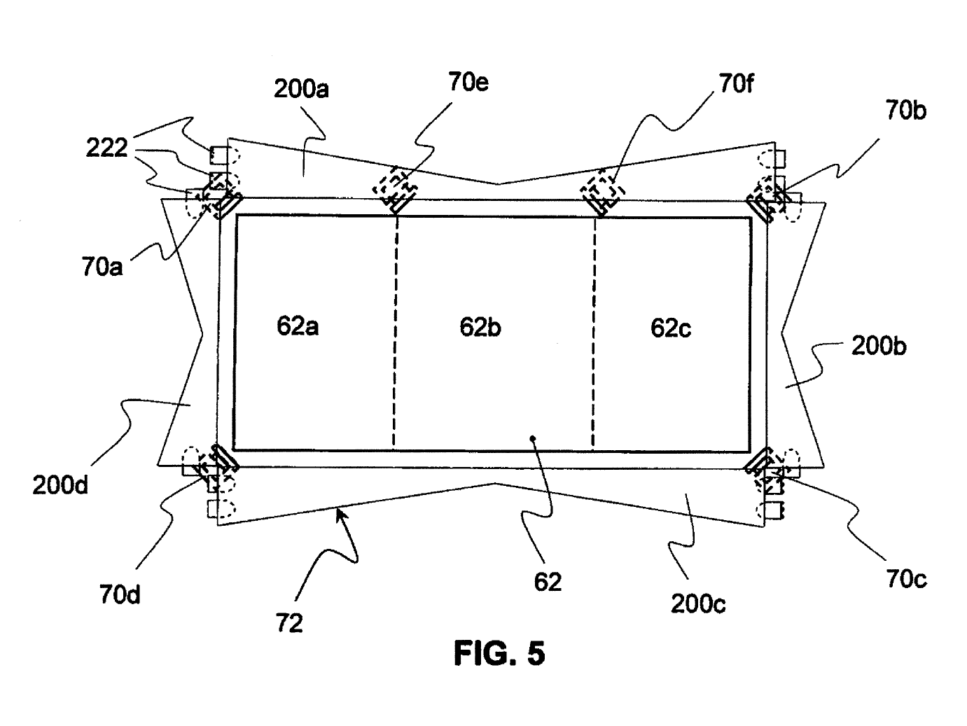

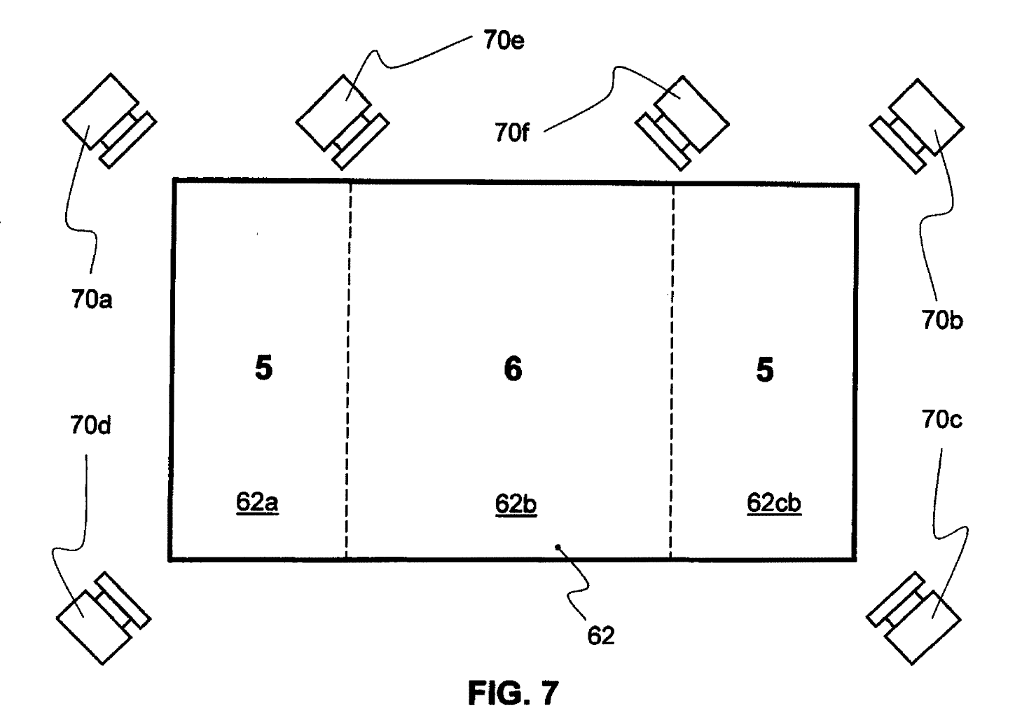

In this embodiment, each of the imaging devices 70a to 70f is in the form of a digital camera device that has a field of view of approximately 90 degrees. The imaging devices 70a to 70d are positioned adjacent the four corners of the input area 62 and look generally across the entire input area 62. Two laterally spaced imaging devices 70e and 70f are also positioned along one major side of the input area 62 intermediate the imaging devices 70a and 70b. The imaging devices 70e and 70f are angled in opposite directions and look towards the center of the input area 62 so that each imaging device 70e and 70f looks generally across two-thirds of the input area 62. This arrangement of imaging devices divides the input area 62 into three (3) zones or input regions, namely a left input region 62a, a central input region 62b and a right input region 62c as shown in FIGS. 5 and 7. The left input region 62a is within the fields of view of five (5) imaging devices, namely imaging devices 70a, 70b, 70c, 70d and 70f. The right input region 62c is also within the fields of view of five (5) imaging devices, namely imaging devices 70a, 70b, 70c, 70d and 70e. The central input region 62b is within the fields of view of all six (6) imaging devices 70a to 70f.

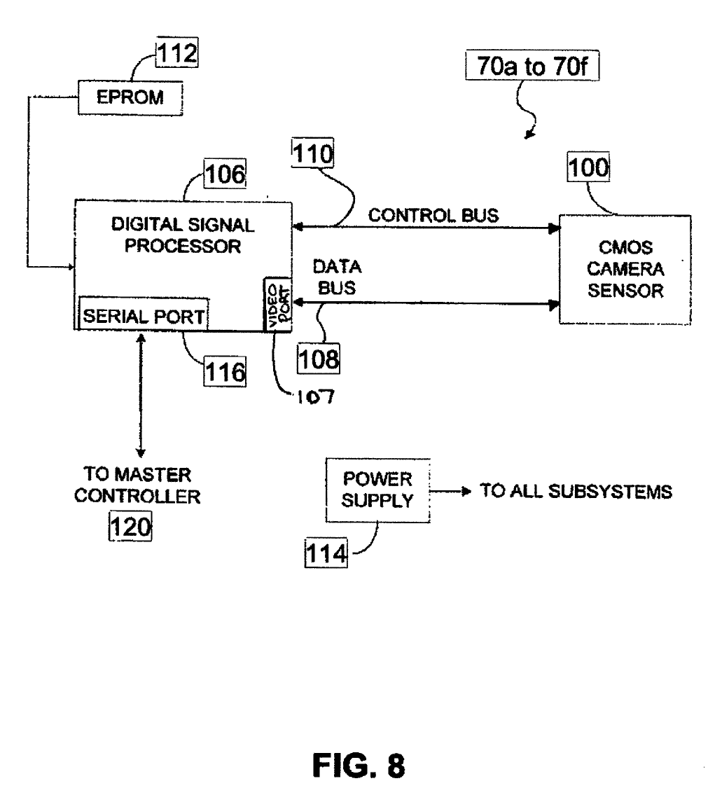

FIG. 8 is a schematic block diagram of one of the imaging devices. As can be seen, the imaging device comprises a two-dimensional CMOS image sensor 100 having an associated lens assembly that provides the image sensor 100 with a field of view of the desired width. The image sensor 100 communicates with and outputs image frame data to a digital signal processor (DSP) 106 via its parallel port 107 over a data bus 108. The image sensor 100 and DSP 106 also communicate over a bi-directional control bus 110 allowing the DSP 106 to control the frame rate of the image sensor 100. A boot electronically programmable read only memory (EPROM) 112, which stores image sensor calibration parameters, is connected to the DSP 106 thereby to allow the DSP to control image sensor exposure, gain, array configuration, reset and initialization. The imaging device components receive power from a power supply 114. The DSP 106 processes the image frame data received from the image sensor 100 and provides target data to a master controller 120 via its serial port 116 when one or more pointers appear in image frames captured by the image sensor 100.

The CMOS image sensor 100 in this embodiment is an Aptina MT9V022 image sensor configured for a 30×752 pixel sub-array that can be operated to capture image frames at high frame rates including those in excess of 960 frames per second. The DSP 106 is manufactured by Analog Devices under part number ADSP-BF524.

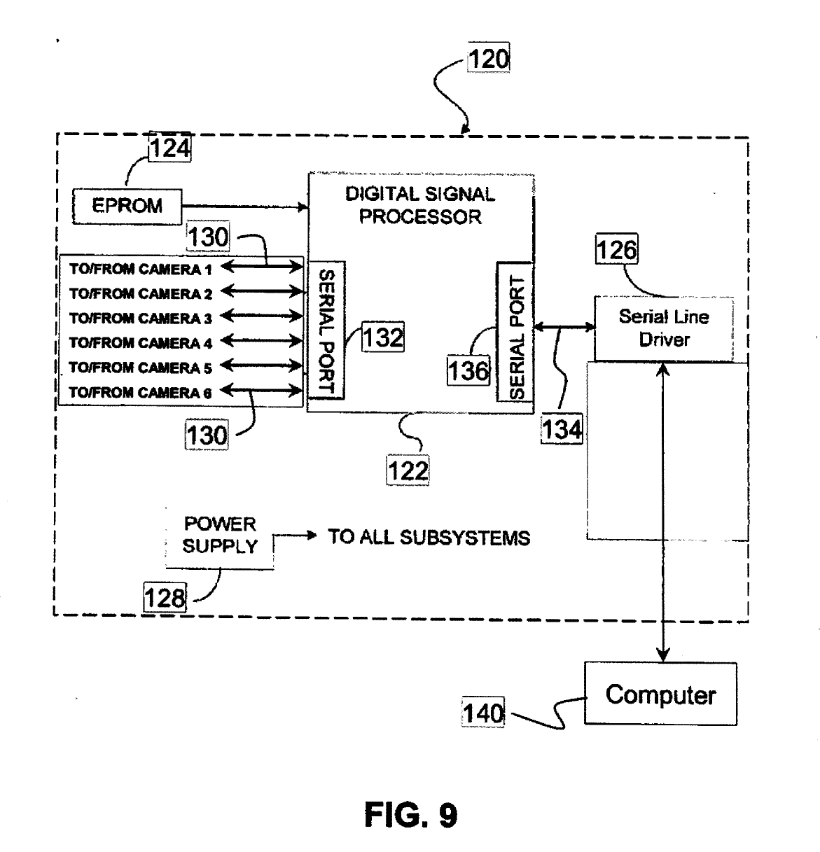

Each of the imaging devices 70a to 70f communicates with the master processor 120 which is best shown in FIG. 9. Master controller 120 is accommodated by the housing 52 and comprises a DSP 122 having a first serial input/output port 132 and a second serial input/output port 136. The master controller 120 communicates with the imaging devices 70a to 70f via first serial input/output port over communication lines 130. Target data received by the DSP 122 from the imaging devices 70a to 70f is processed by the DSP 122 as will be described. DSP 122 communicates with a general purpose computing device 140 via the second serial input/output port 136 and a serial line driver 126 over communication lines 134. Master controller 120 further comprises a boot EPROM 124 storing interactive input system parameters that are accessed by the DSP 122. The master controller components received power from a power supply 128. In this embodiment, the DSP 122 is also manufactured by Analog Devices under part number ADM222. The serial line driver 138 is manufactured by Analog Devices under part number ADM222.

The master controller 120 and each imaging device follow a communication protocol that enables bi-directional communications via a common serial cable similar to a universal serial bus (USB). The transmission bandwidth is divided into thirty-two (32) 16-bit channels. Of the thirty-two channels, four (4) channels are assigned to each of the DSPs 106 in the imaging devices 70a to 70f and to the DSP 122 in the master controller 120. The remaining channels are unused and may be reserved for further expansion of control and image processing functionality (e.g., use of additional imaging devices). The master controller 120 monitors the channels assigned to the DSPs 106 while the DSP 106 in each of the imaging devices monitors the five (5) channels assigned to the master controller DSP 122. Communications between the master controller 120 and each of the imaging devices 70a to 70f are performed as background processes in response to interrupts.

In this embodiment, the general purpose computing device 140 is a computer or other suitable processing device and comprises for example, a processing unit, system memory (volatile and/or non-volatile memory), other removable or non-removable memory (hard drive, RAM, ROM, EEPROM, CD-ROM, DVD, flash memory, etc.), and a system bus coupling various components to the processing unit. The general purpose computing device 140 may also comprise a network connection to access shared or remote drives, one or more networked computers, or other networked devices. The processing unit runs a host software application/operating system and provides display output to the display panel 60. During execution of the host software application/operating system, a graphical user interface is presented on the display surface of the display panel 60 allowing one or more users to interact with the graphical user interface via pointer input within the input area 62. In this manner, freeform or handwritten ink objects as well as other objects can be input and manipulated via pointer interaction with the display surface of the display panel 60.

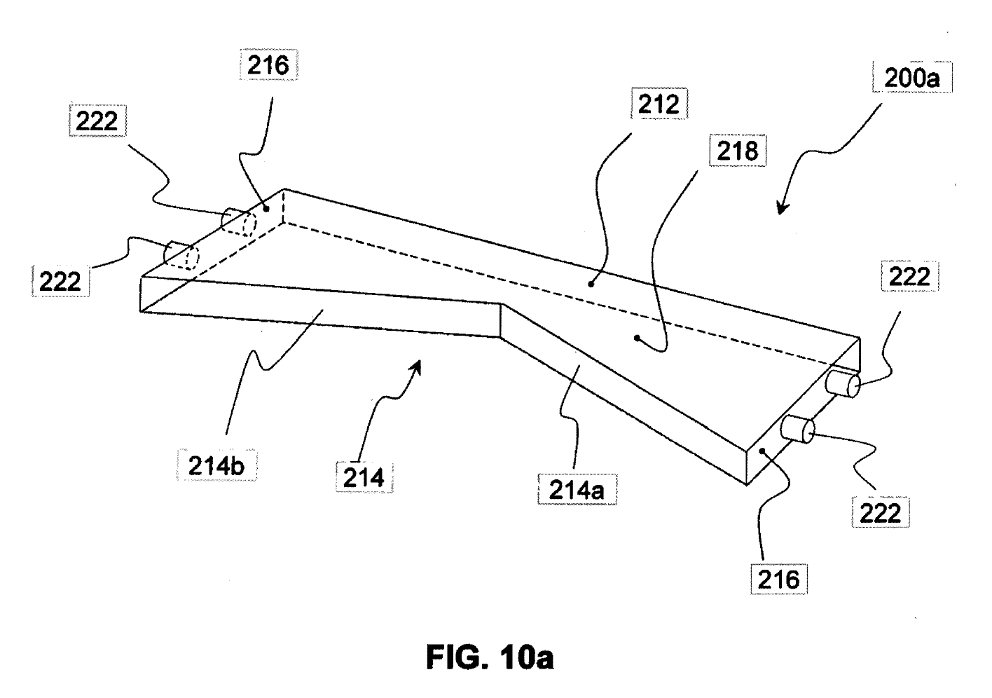

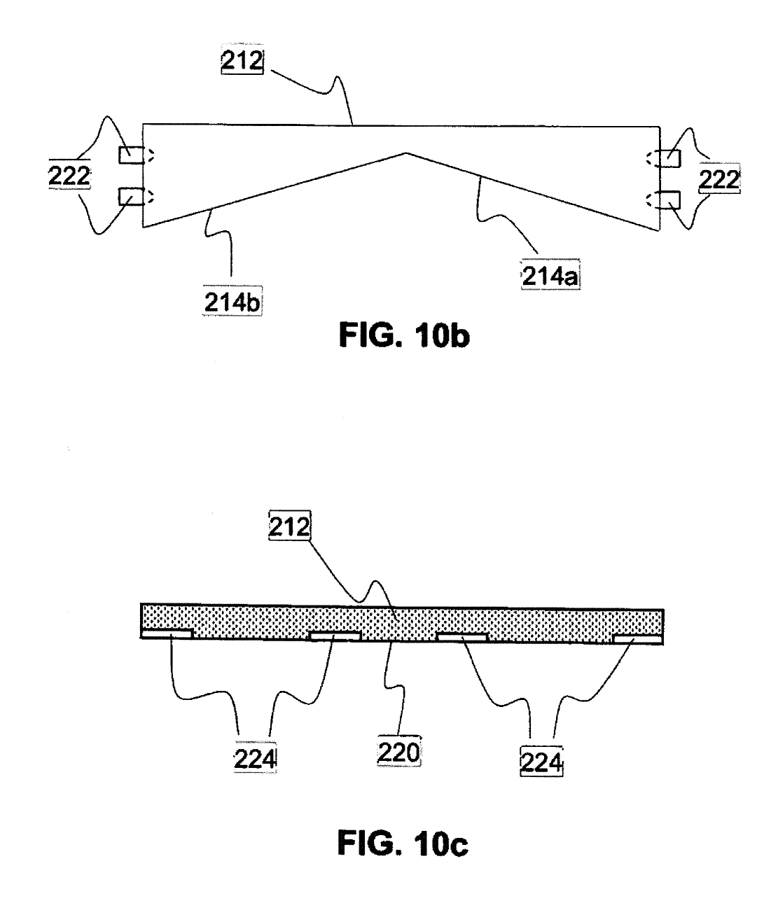

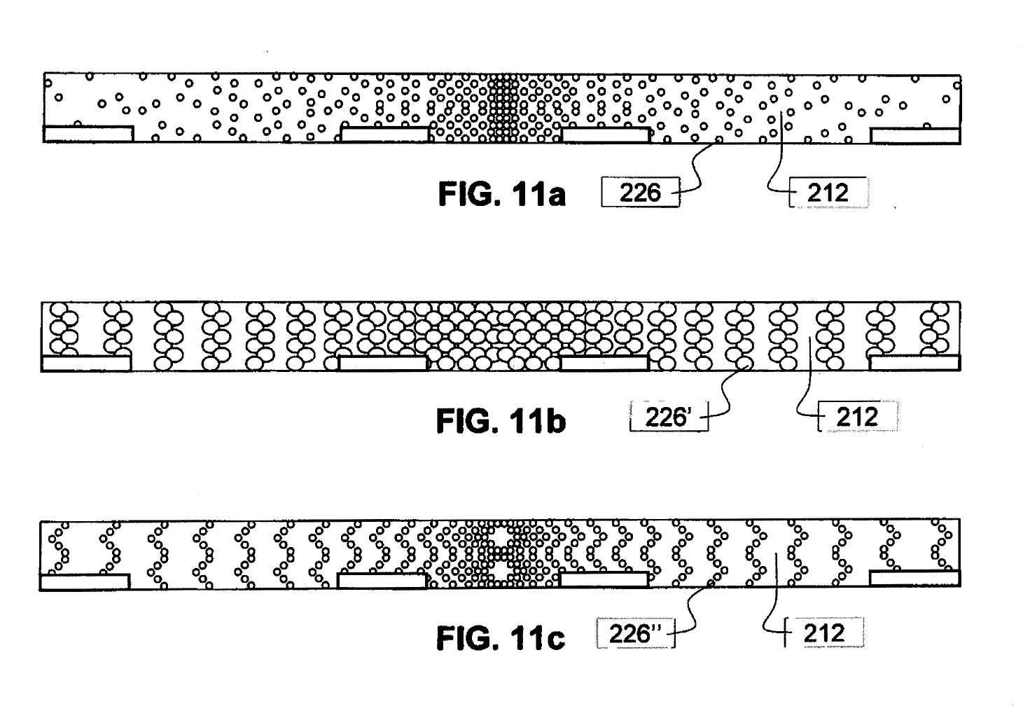

The illuminated bezel 72 comprises four bezel segments 200a to 200d with each bezel segment extending substantially along the entire length of a respective side of the input area 62. FIGS. 10a to 10c better illustrate the bezel segment 200a. In this embodiment, the bezel segment 200a is formed of a homogeneous piece of clear, light transmissive material such as for example Lexan®, Plexiglas, acrylic or other suitable material. The bezel segment 200a comprises a front surface 212 that extends substantially along the entire length of the respective major side of the input area 62, a back surface 214, two side surfaces 216, a top surface 218 and a bottom surface 220. The front, back and side surfaces of the bezel segment 200a are generally normal to the plane of the display surface of display panel 60. Each side surface 216 has a pair of laterally spaced bores formed therein that accommodate light sources. In this particular embodiment, the light sources are infrared (IR) light emitting diodes (LEDs) 222 although LEDs or other suitable light sources that emit light at different wavelengths may be used. The top, bottom, side and back surfaces of the bezel segment 200a are coated with a reflective material to reduce the amount of light that leaks from the bezel segment via these surfaces. The front surface 212 of the bezel segment 200a is textured or covered with a diffusive material to produce a diffusive surface that allows light to escape from the bezel segment into the input area 62. In particular, in this embodiment, the front surface 212 of the bezel segment is textured to form a dimple pattern with the density of the dimples 226 increasing towards the center of the bezel segment 200a to allow more light to escape from the center of the bezel segment as compared to the ends of the bezel segment as shown in FIG. 11a.

The geometry of the bezel segment 200a is such that the reflective back surface 214 is v-shaped with the bezel segment being most narrow at its midpoint. As a result, the reflective back surface 214 defines a pair of angled reflective surface panels 214a and 214b with the ends of the panels that are positioned adjacent the center of the bezel segment 200a being closer to the front surface 212 than the opposite ends of the reflective surface panels. This bezel segment configuration compensates for the attenuation of light emitted by the IR LEDs 222 that propagates through the body of the bezel segment 200a by tapering towards the midpoint of the bezel segment 200a. The luminous emittance of the bezel segment 200a is maintained generally at a constant across the front surface 212 of the bezel segment by reducing the volume of the bezel segment 200a further away from the IR LEDs 222 where the attenuation has diminished the light flux. By maintaining the luminous emittance generally constant across the bezel segment, the amount of backlighting exiting the front surface 212 of the bezel segment is a generally uniform density. This helps to make the bezel segment backlight illumination appear uniform to the imaging devices 70a to 70f.

Shallow notches 224 are provided in the bottom surface 220 of the bezel segment 200a to accommodate the imaging devices 70a, 70e, 70f and 70b. In this manner, the imaging devices are kept low relative to the front surface 212 so that the imaging devices block as little of the backlight illumination escaping the bezel segment 200a via the diffusive front surface 212 as possible while still being able to view the input area 62, and thus, the height of the bezel segment can be reduced.

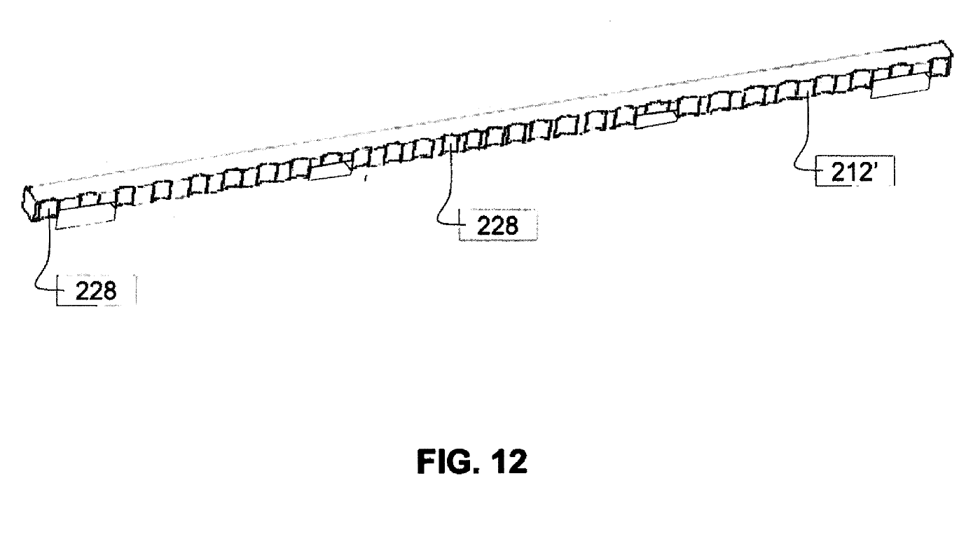

FIGS. 11b and 11c show alternative dimple patterns provided on the front surface 212 of the bezel segment with the density of the dimples 226′ and 226″ increasing towards the center of the bezel segment to allow more light to escape from the center of the bezel segment as compared to the ends of the bezel segment. FIG. 12 shows yet another alternative front surface 212′ of the bezel segment configured to allow more light to escape from the center of the bezel segment as compared to the ends of the bezel segment. As can be seen, in this embodiment spaced vertical grooves or slits 228 are formed in the front surface 212′ with the density of the grooves or slits 228 increasing towards the center of the bezel segment.

The bezel segment 200c extending along the opposite major side of the input area 62 has a similar configuration to that described above with the exception that the number and positioning of the notches 224 is varied to accommodate the imaging devices 70c and 70d that are covered by the bezel segment 200c. The bezel segments 200b and 200d extending along the shorter sides of the input area 62 also have a similar configuration to that described above with the exceptions that the side surfaces of the bezel segments only accommodate a single IR LED 222 (as the lighting requirements are reduced due to the decreased length) and the number and the positioning of the notches 224 is varied to accommodate the imaging devices that are covered by the bezel segments 200b and 200d.

During general operation of the interactive input system 50, the IR LEDs 222 of the bezel segments 200a to 200d are illuminated resulting in infrared backlighting escaping from the bezel segments via their front surfaces 212 and flooding the input area 62. As mentioned above, the design of the bezel segments 200a to 200d is such that the backlight illumination escaping each bezel segment is generally even along the length of the bezel segment. Each imaging device which looks across the input area 62 is conditioned by its associated DSP 106 to acquire image frames. When no pointer is in the field of view of an imaging device, the imaging device sees the infrared backlighting emitted by the bezel segments and thus, generates a “white” image frame. When a pointer is positioned within the input area 62, the pointer occludes infrared backlighting emitted by at least one of the bezel segments. As a result, the pointer, referred to as a target, appears in captured image frames as a “dark” region on a “white” background. For each imaging device, image data acquired by its image sensor 100 is processed by the DSP 106 to determine if one or more targets (e.g. pointers) is/are believed to exist in each captured image frame. When one or more targets is/are determined to exist in a captured image frame, pointer characteristic data is derived from that captured image frame identifying the target position(s) in the captured image frame.

The pointer characteristic data derived by each imaging device is then conveyed to the master controller 120. The DSP 122 of the master controller in turn processes the pointer characteristic data to allow the location(s) of the target(s) in (x,y) coordinates relative to the input area 62 to be calculated using well known triangulation.

The calculated target coordinate data is then reported to the general purpose computing device 140, which in turn records the target coordinate data as writing or drawing if the target contact(s) is/are write events or injects the target coordinate data into the active application program being run by the general purpose computing device 140 if the target contact(s) is/are mouse events. As mentioned above, the general purpose computing device 140 also updates the image data conveyed to the display panel 60 so that the image presented on the display surface of the display panel 60 reflects the pointer activity.

When a single pointer exists in the image frames captured by the imaging devices 70a to 70f, the location of the pointer in (x,y) coordinates relative to the input area 62 can be readily computed using triangulation. When multiple pointers exist in the image frames captured by the imaging devices 70a to 70f, computing the positions of the pointers in (x,y) coordinates relative to the input area 62 is more challenging as a result of pointer ambiguity and occlusion issues.

As mentioned above, pointer ambiguity arises when multiple targets are positioned within the input area 62 at different locations and are within the fields of view of multiple imaging devices. If the targets do not have distinctive markings to allow them to be differentiated, the observations of the targets in each image frame produce real and false target results that cannot be readily differentiated.

Pointer occlusion arises when a target in the field of view of an imaging device occludes another target in the field of view of the same imaging device, resulting in observation merges as will be described.

Depending on the position of an imaging device relative to the input area 62 and the position of a target within the field of view of the imaging device, an imaging device may or may not see a target brought into its field of view adequately to enable image frames acquired by the imaging device to be used to determine the position of the target relative to the input area 62. Accordingly, for each imaging device, an active zone within the field of view of the imaging device is defined. The active zone is an area that extends to a distance of radius ‘r’ away from the imaging device. This distance is pre-defined and based on how well an imaging device can measure an object at a certain distance. When one or more targets appear in the active zone of the imaging device, image frames acquired by the imaging device are deemed to observe the targets sufficiently such that the observation for each target within the image frame captured by the imaging device is processed. When a target is within the field of view of an imaging device but is beyond the active zone of the imaging device, the observation of the target is ignored. When a target is within the radius ‘r’ but outside of the field of view of the imaging device, it will not be seen and that imaging device is not used during target position determination.

When each DSP 106 receives an image frame, the DSP 106 processes the image frame to detect the existence of one or more targets. If one or more targets exist in the active zone, the DSP 106 creates an observation for each target in the active zone. Each observation is defined by the area formed between two straight lines, namely one line that extends from the focal point of the imaging device and crosses the left edge of the target, and another line that extends from the imaging device and crosses the right edge of the target. The DSP 90 then coveys the observation(s) to the master controller 120.

The master controller 120 in response to received observations from the imaging devices 70a to 70f examines the observations to determine observations that overlap. When multiple imaging devices see the target resulting in observations that overlap, the overlapping observations are referred to as a candidate. The intersecting lines forming the overlapping observations define the perimeter of the candidate and delineate a bounding box. The center of the bounding box in (x,y) coordinates is computed by the master controller using triangulation thereby to locate the target within the input area.

When a target is in an input region of the input area 62 and all imaging devices whose fields of view encompass the input region and whose active zones include at least part of the target, create observations that overlap, the resulting candidate is deemed to be a consistent candidate. The consistent candidate may represent a real target or a phantom target.

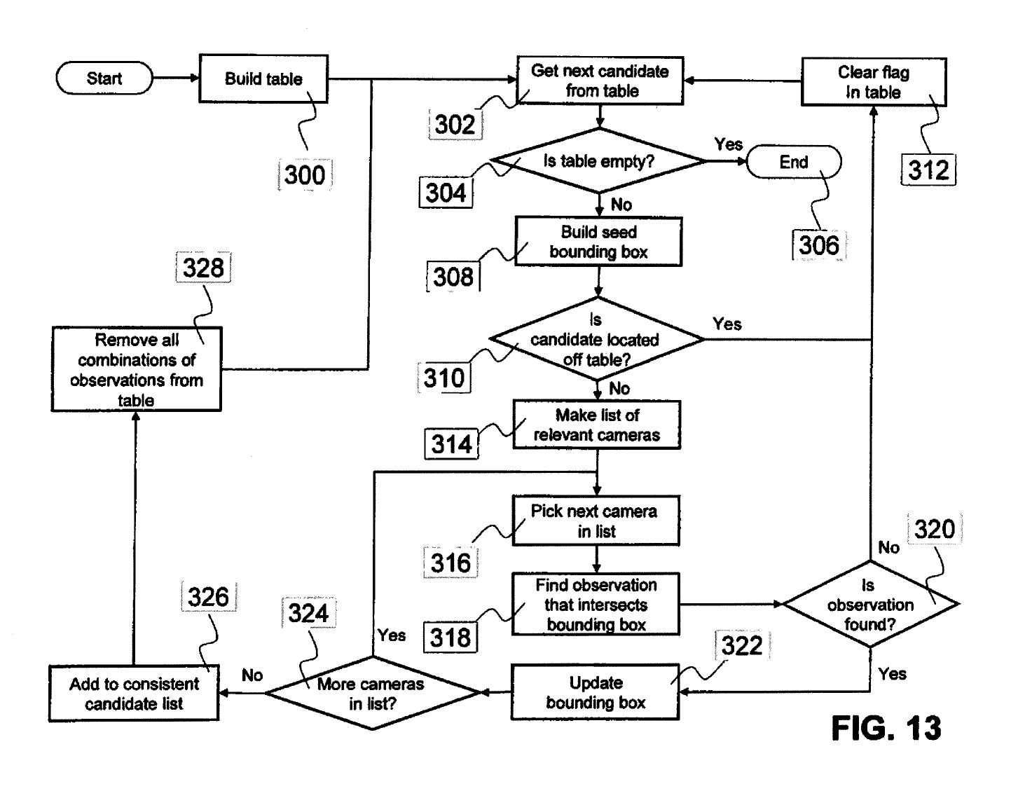

The master controller 120 executes a candidate generation procedure to determine if any consistent candidates exist in captured image frames. FIG. 13 illustrates steps performed during the candidate generation procedure. During the candidate generation procedure, a table is initially generated, or “built”, that lists all imaging device observations so that the observations generated by each imaging device can be cross referenced with all other observations to see if one or more observations overlap and result in a candidate (step 300).

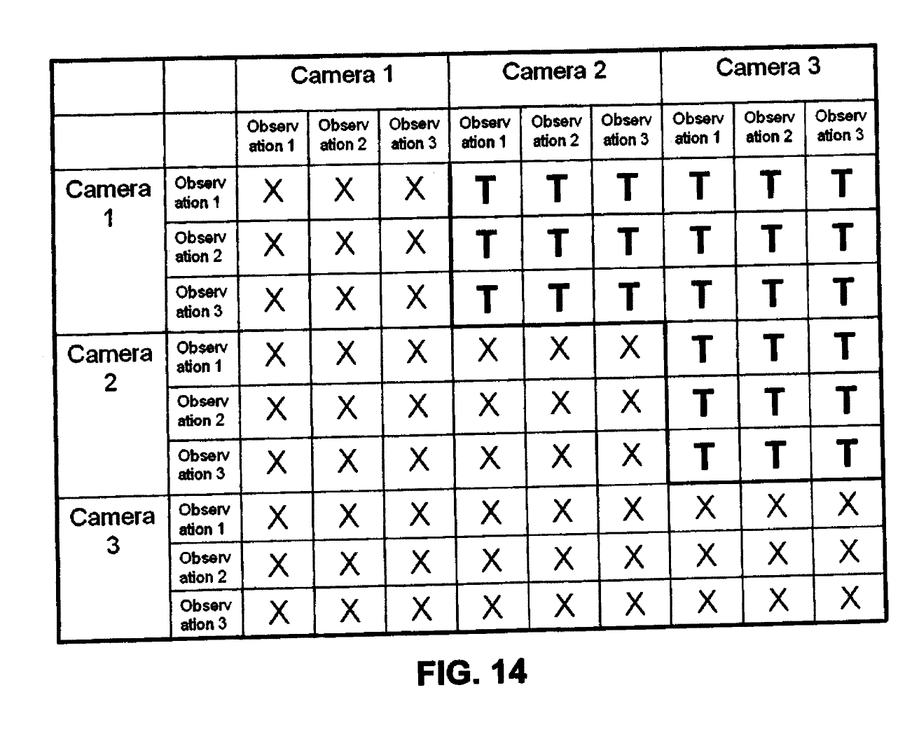

As the interactive input system 50 includes six (6) imaging devices 70a to 70f and is capable of simultaneously tracking eight (8) targets, the maximum number of candidates that is possible is equal to nine-hundred and sixty (960). For ease of illustration, FIG. 14 shows an exemplary table identifying three imaging devices with each imaging device generating three (3) observations. Cells of the table with an “X” indicate observations that are not cross-referenced with other observations. For example, imaging device observations cannot be cross-referenced with any of their own observations. Cells of the table that are redundant are also not cross-referenced. In FIG. 14, cells of the table designated with a “T” are processed. In this example of three imaging devices and three targets, the maximum number of candidates to examine is twenty-seven (27). Once the table has been created at step 300, the table is examined from left to right and starting on the top row and moving downwards to determine if the table includes a candidate (step 302). If the table is determined to be empty (step 304), and therefore does not include any candidates, the candidate generation procedure ends (step 306).

At step 304, if the table is not empty and a candidate is located, a flag is set in the table for the candidate and the intersecting lines that make up the bounding box for the candidate resulting from the two imaging device observations are defined (step 308). A check is then made to determine if the position of the candidate is completely beyond the input area 62 (step 310). If the candidate is determined to be completely beyond the input area 62, the flag that was set in the table for the candidate is cleared (step 312) and the procedure reverts back to step 302 to determine if the table includes another candidate.

At step 310, if the candidate is determined to be partially or completely within the input area 62, a list of the imaging devices that have active zones encompassing at least part of the candidate is created excluding the imaging devices whose observations were used to create the bounding box at step 308 (step 314). Once the list of imaging devices has been created, the first imaging device in the list is selected (step 316). For the selected imaging device, each observation created for that imaging device is examined to see if it intersects with the bounding box created at step 308 (steps 318 and 320). If no observation intersects the bounding box, the candidate is determined not to be a consistent candidate. As a result, the candidate generation procedure reverts back to step 312 and the flag that was set in the table for the candidate is cleared. At step 320, if an observation that intersects the bounding box is located, the bounding box is updated using the lines that make up the observation (step 322). A check is then made to determine if another non-selected imaging device exists in the list (step 324). If so, the candidate generation procedure reverts back to step 316 and the next imaging device in the list is selected.

At step 324, if all of the imaging devices have been selected, the candidate is deemed to be a consistent candidate and is added to a consistent candidate list (step 326). Once the candidate has been added to the consistent candidate list, the center of the bounding box delineated by the intersecting lines of the overlapping observations forming the consistent candidate in (x,y) coordinates is computed and the combinations of observations that are related to the consistent candidate are removed from the table (step 328). Following this, the candidate generation procedure reverts back to step 302 to determine if another candidate exists in the table. As will be appreciated, the candidate generation procedure generates a list of consistent candidates representing targets that are seen by all of the imaging devices whose fields of view encompass the target locations. For example, a consistent candidate resulting from a target in the central input region 62b is seen by all six imaging devices 70a to 70f whereas a consistent candidate resulting from a target in the left or right input region 62a or 62c is only seen by five imaging devices.

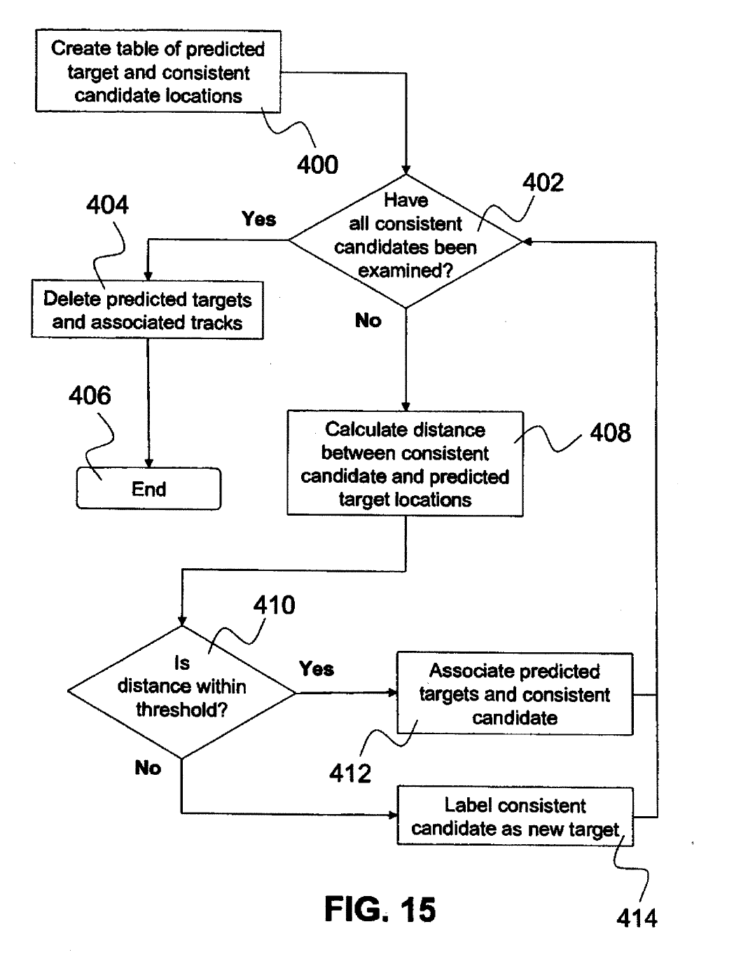

The master controller 120 also executes an association procedure as best shown in FIG. 15 to associate candidates with existing targets. During the association procedure, a table is created that contains the coordinates of predicted target locations generated by a tracking procedure as will be described, and the location of the consistent candidates in the consistent candidate list created during the candidate generation procedure (step 400). A check is then made to determine if all of the consistent candidates have been examined (step 402). If it is determined that all of the consistent candidates have been examined, any predicted targets that are not associated with a consistent candidate are deemed to be associated with a dead path. As a result, these predicted target location and previous tracks associated with these predicted targets are deleted (step 404) and the association procedure is terminated (step 406).

At step 402, if it is determined that one or more of the consistent candidates have not been examined, the next unexamined consistent candidate in the list is selected and the distance between the selected consistent candidate and all of the predicted target locations is calculated (step 408). A check is then made to determine whether the distance between the selected consistent candidate and a predicted target location falls within a threshold (step 410). If the distance falls within the threshold, the consistent candidate is associated with the predicted target (step 412). Alternatively, if the distance is beyond the threshold, the selected consistent candidate is labelled as a new target (step 414). Following either of steps 412 and 414, the association procedure reverts back to step 402 to determine if all of the consistent candidates in the selected consistent candidate list have been selected. As a result, the association procedure identifies each consistent candidate as either a new target within the input area 62 or an existing target.

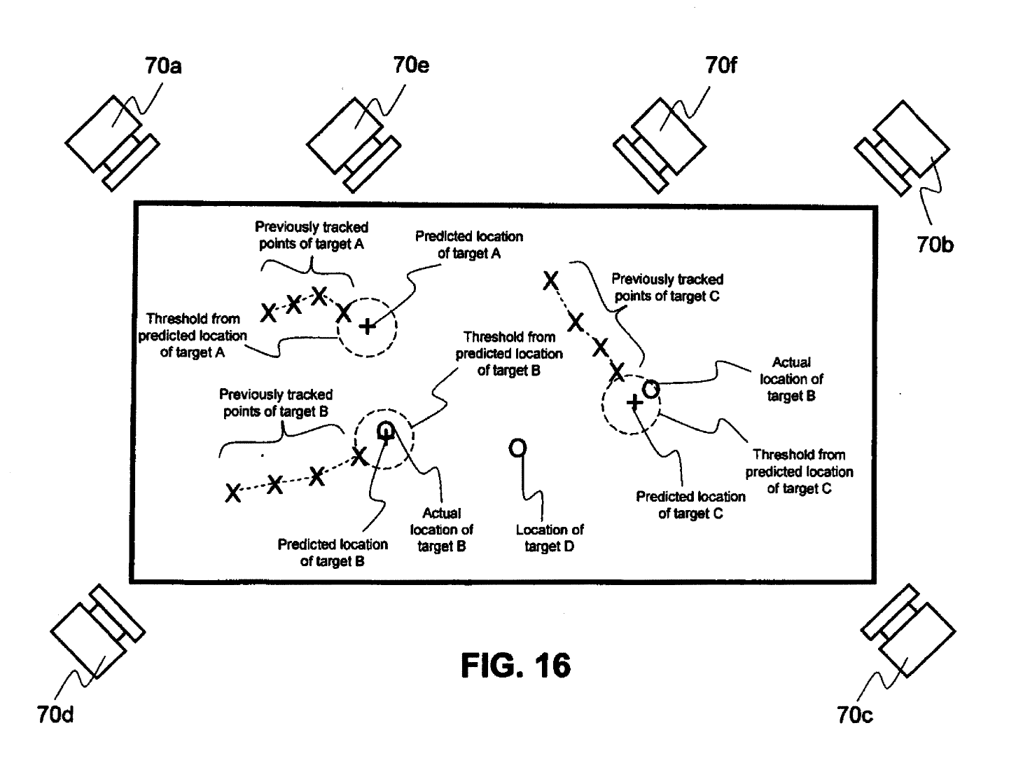

FIG. 16 shows an example of the interactive input system 50 tracking three pointers A, B and C. The locations of four previously triangulated targets for pointers A, B and C are represented by an “X”. From these previously tracked target locations, an estimate (e.g. predicted target location) is made for where the location of the pointer should appear in the current image frame, and is represented by a “+”. Since a user can manipulate a pointer within the input area 62 at an approximate maximum velocity of 4 m/s, and if the interactive input system 50 is running at 100 frames per second, then the actual location of the pointer should appear within [400 cm/s/100 frames/s×1 frame=4 cm] 4 centimeters of the predicted target location. This threshold is represented by a broken circle surrounding the predicted target locations. Pointers B and C are both located within the threshold of their predicted target locations and are thus associated with those respective previously tracked target locations. The threshold around the predicted target location of pointer A does not contain pointer A, and is therefore considered to be a dead track and no longer used in subsequent image processing. Pointer D is seen at a position outside all of the calculated thresholds and is thus considered a new target and will continue to be tracked in subsequent image frames.

The master controller 120 executes a state estimation procedure to determine the status of each candidate, namely whether each candidate is clear, merged or irrelevant. If a candidate is determined to be merged, a disentanglement process is initiated. During the disentanglement process, the state metrics of the targets are computed to determine the positions of partially and completely occluded targets. Initially, during the state estimation procedure, the consistent candidate list generated by the candidate generation procedure, the candidates that have been associated with existing targets by the association procedure, and the observation table are analyzed to determine whether each imaging device had a clear view of each candidate in its field of view or whether a merged view of candidates within its field of view existed. Candidates that are outside of the active areas of the imaging devices are flagged as being irrelevant.

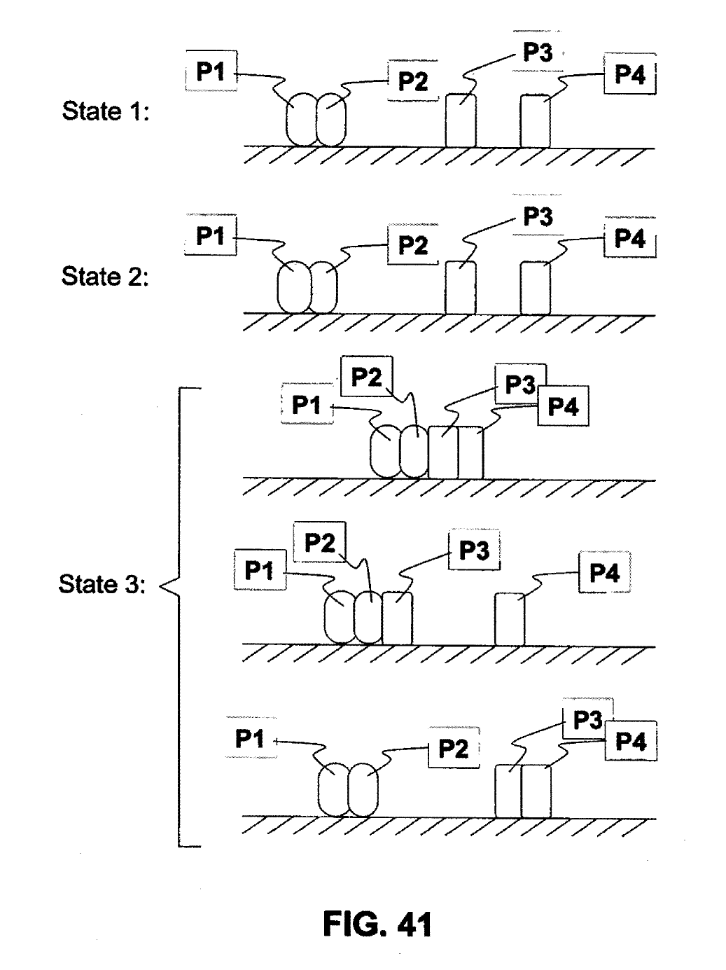

The target and phantom track identifications from the previous image frames are used as a reference to identify true target merges. When a target merge for an imaging device is deemed to exist, the disentanglement process for that imaging device is initiated. The disentanglement process makes use of the Viterbi algorithm. Depending on the number of true merges, the Viterbi algorithm assumes a certain state distinguishing between a merge of only two targets and a merge of more than two targets. In this particular embodiment, the disentanglement process is able to occupy one of the three states as shown in FIG. 41, which depicts a four-input situation.

A Viterbi state transition method computes a metric for each of the three states. In this embodiment, the metrics are computed over five (5) image frames including the current image frame and the best estimate on the current state is given to the branch with the lowest level. The metrics are based on the combination of one dimensional predicted target positions and target widths with one dimensional merged observations. The state with the lowest branch is selected and is used to associate targets within a merge thereby to enable the predictions to disentangle merge observations. For states 1 and 2, the disentanglement process yields the left and right edges for the merged targets. Only the center position for all the merges in state 3 is reported by the disentanglement process.

Once the disentanglement process has been completed, the states flag indicating a merge is cleared and a copy of the merged status before being cleared is maintained. To reduce triangulation inaccuracies due to disentanglement observations, a weighting scheme is used on the disentangled targets. Targets associated with clear observations are assigned a weighting of one (1). Targets associated with merged observations are assigned a weighting in the range from 0.5 to 0.1 depending on how far apart the state metrics are from each other. The greater the distance between state metrics, the higher the confidence of disentangling observations and hence, the higher the weighting selected from the above range.

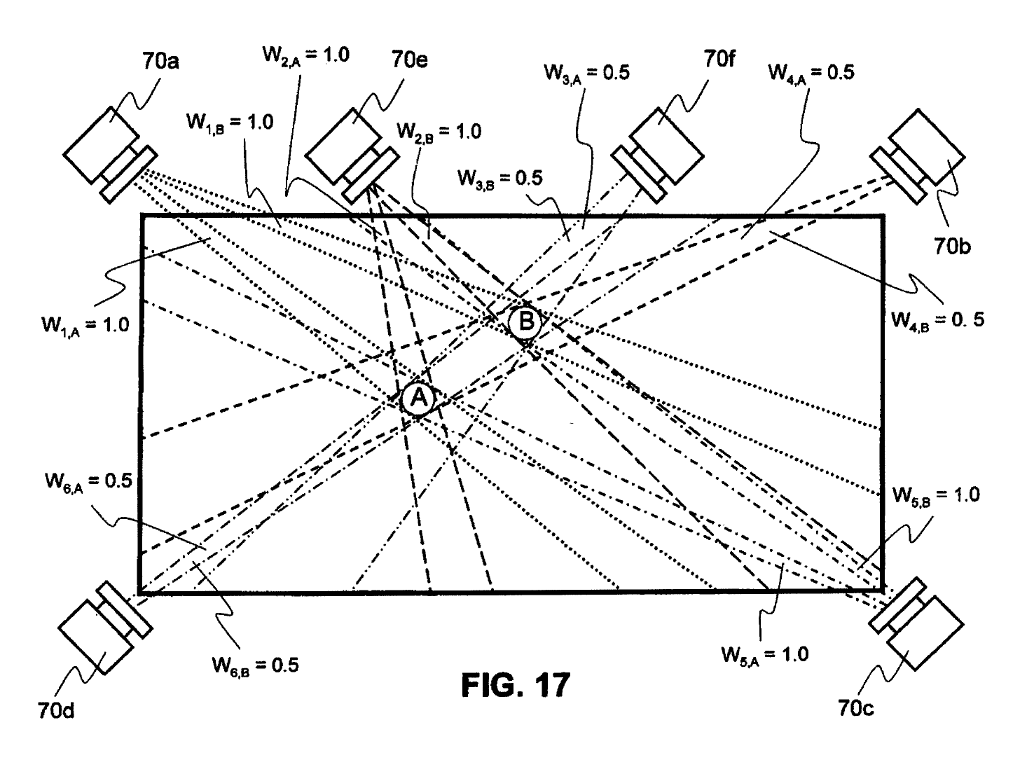

FIG. 17 shows an example of two pointers, A and B, positioned within the input area 62 and being viewed by imaging devices 70a to 70f. Image frames captured by imaging devices 70a, 70e and 70c all have two observations, one of pointer A and the other of pointer B. Image frames captured by imaging devices 70f, 70b, and 70d all have one observation. Since at least one imaging device captured image frames comprising two observations, the state estimation module determines that there must be two pointers within the input area 62. Imaging devices 70a, 70e and 70c each see pointers A and B clearly and so each observation derived from image frames captured by these imaging devices is assigned a weight of 1.0. Imaging devices 70f, 70b and 70d observe only one pointer. As a result it is determined that the two pointers must appear merged to these imaging devices, and therefore a weight of 0.5 is assigned to each observation derived from image frames captured by these imaging devices.

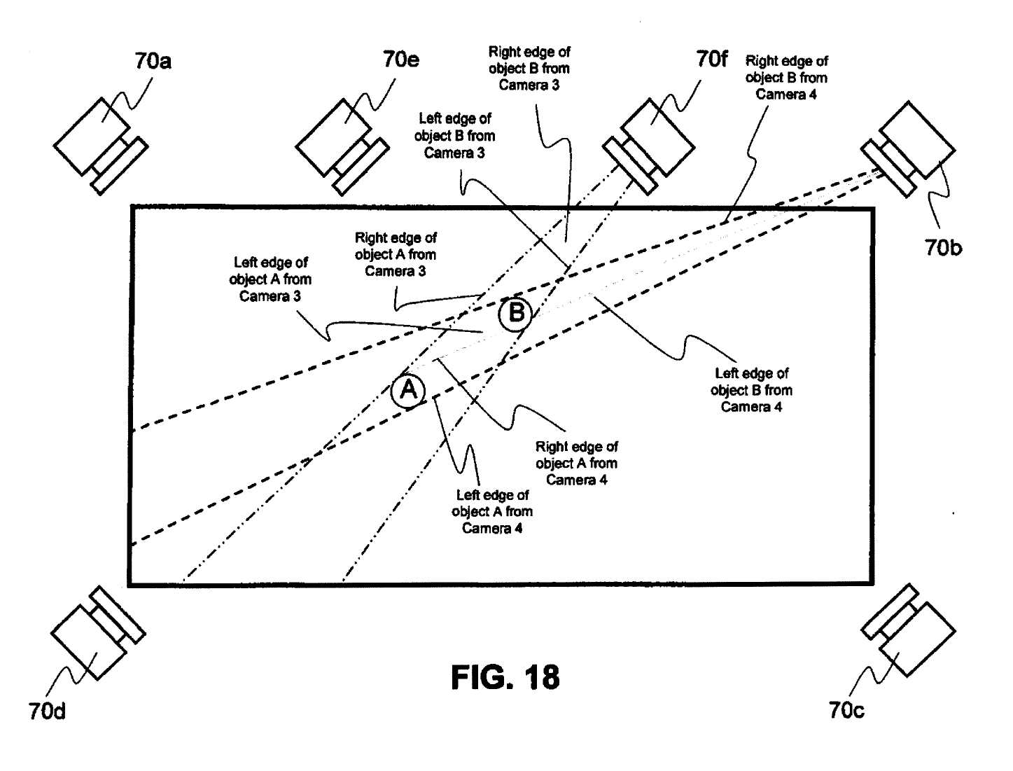

FIG. 18 shows pointers A and B as viewed by imaging devices 70f and 70b. Since these pointers appear merged to these imaging devices, the state estimation procedure approximates the actual position of the pointers based on earlier data. From previous tracking information, the approximate widths of the pointers are known. Since the imaging devices 70f and 70b are still able to view one edge of each of the pointers, the other edge is determined based on the previously stored width of the pointers. The state estimation module calculates the edges of both pointers for both imaging devices 70f and 70b. Once both edges of each pointer are known, the center line for each pointer from each imaging device is calculated.

As mentioned previously, the master controller 120 also executes a tracking procedure to track existing targets. During the tracking procedure, each target seen by each imaging device is examined to determine its center point and a set of radii. The set of radii comprises a radius corresponding to each imaging device that sees the target represented by a line extending from the focal pointer of the imaging device to the center point of the bounding box representing the target. If a target is associated with a pointer, a Kalman filter is used to estimate the current state of the target and to predict its next state. This information is then used to backwardly triangulate the location of the target at the next time step which approximates an observation of the target if the target observation overlaps another target observation seen by the imaging device. If the target is not associated with a candidate, the target is considered dead and the target tracks are deleted from the track list. If the candidate is not associated with a target, and the number of targets is less than the maximum number of permitted targets, in this case eight (8), the candidate is considered to be a new target.

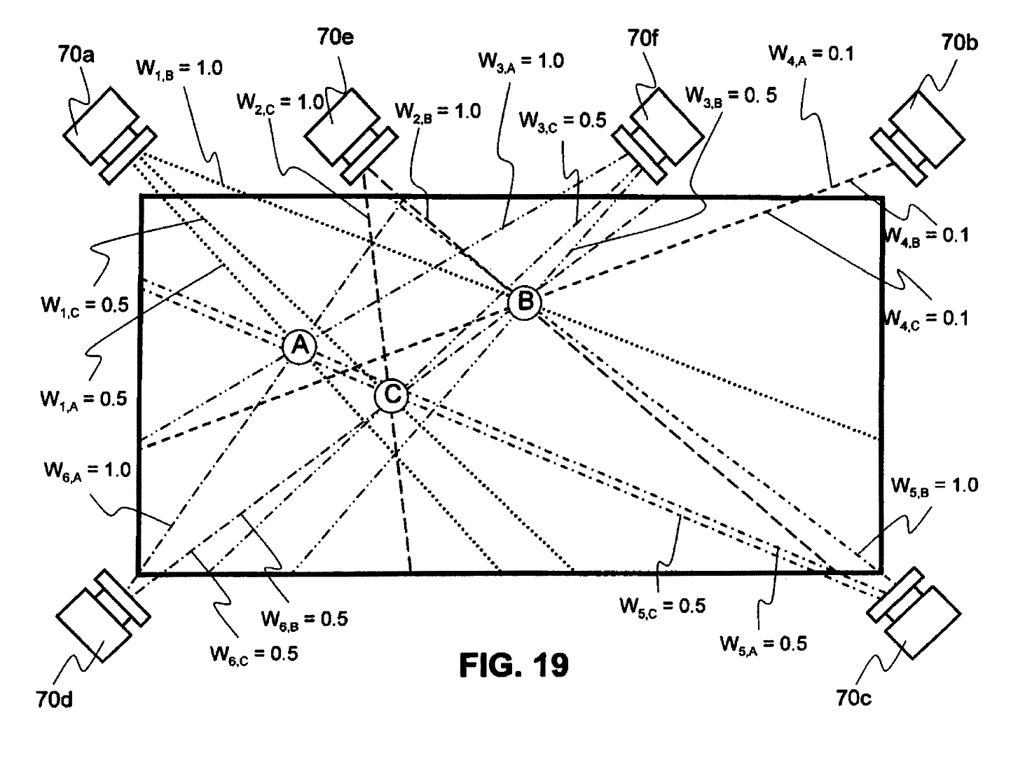

FIG. 19 shows an input situation, similar to that of FIGS. 16 to 18. The centerline for each imaging device observation of each target is shown along with the corresponding assigned weight. Note that the centerlines of pointers A and C as seen from imaging device 70a can be determined, along with the centerline of pointers B and C as seen from imaging device 70f. The centerline of pointers A, B and C as seen from imaging device 70b could not be determined and as a result, the center of the merged observation is used for the centerline. The value of the weight assigned to these observations is low.

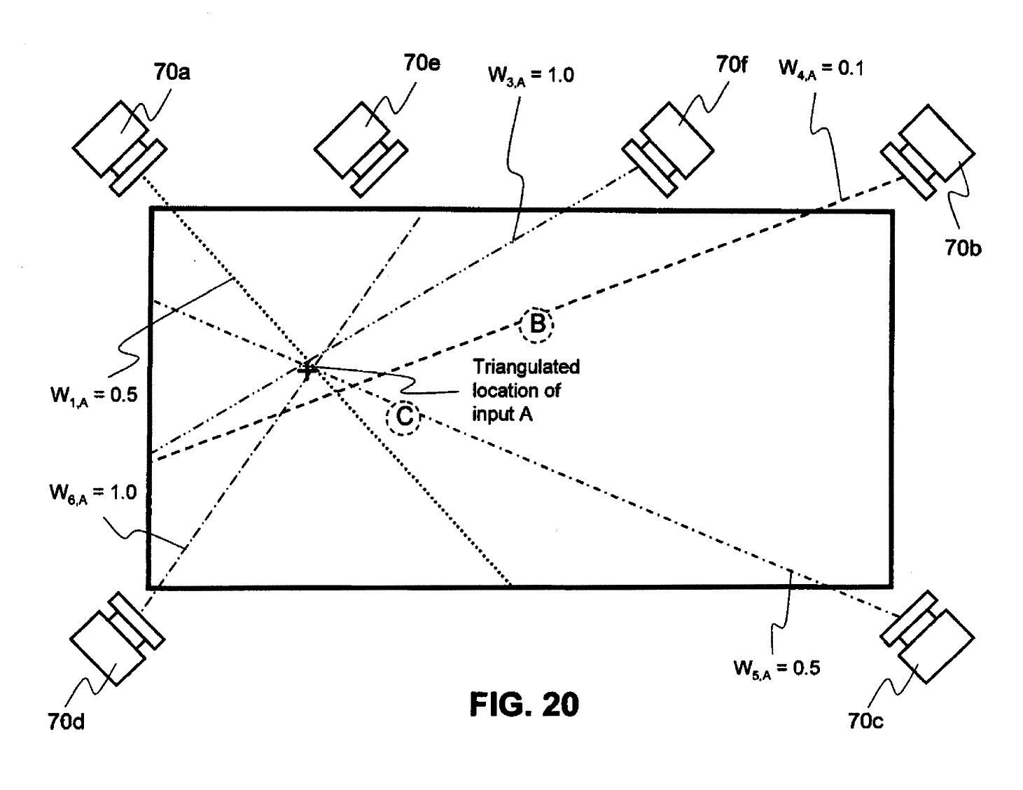

FIG. 20 shows the triangulated location of pointer A from the centerlines of the observations from imaging devices 70a, 70f and 70b. Imaging device 70f has a clear view of the pointer A and has an observation with a high weight. The observation of imaging device 70a has a medium weight, and the observation of imaging device 70b has a low weight. The triangulated location as a result is located closer to the intersection of the two lines with the higher weight since those observations are more reliable.

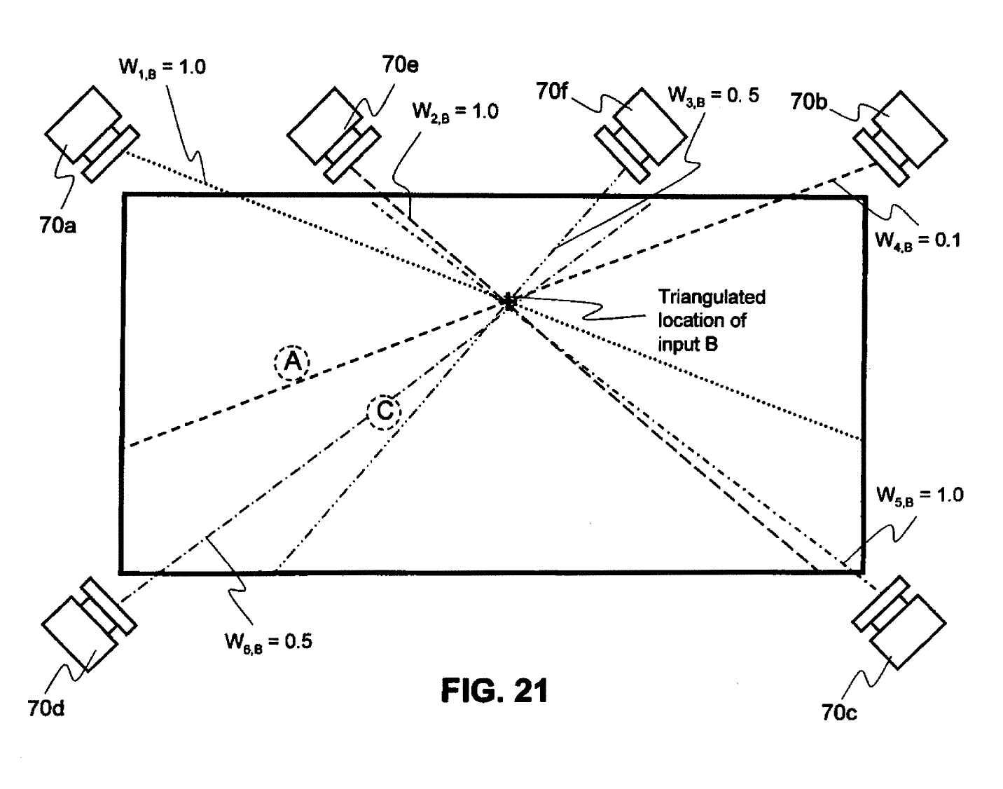

Similar to FIG. 20, FIG. 21 shows the centerline and triangulated position for pointer B. The triangulation is dominated by the highly weighted observations from imaging devices 70a and 70e.

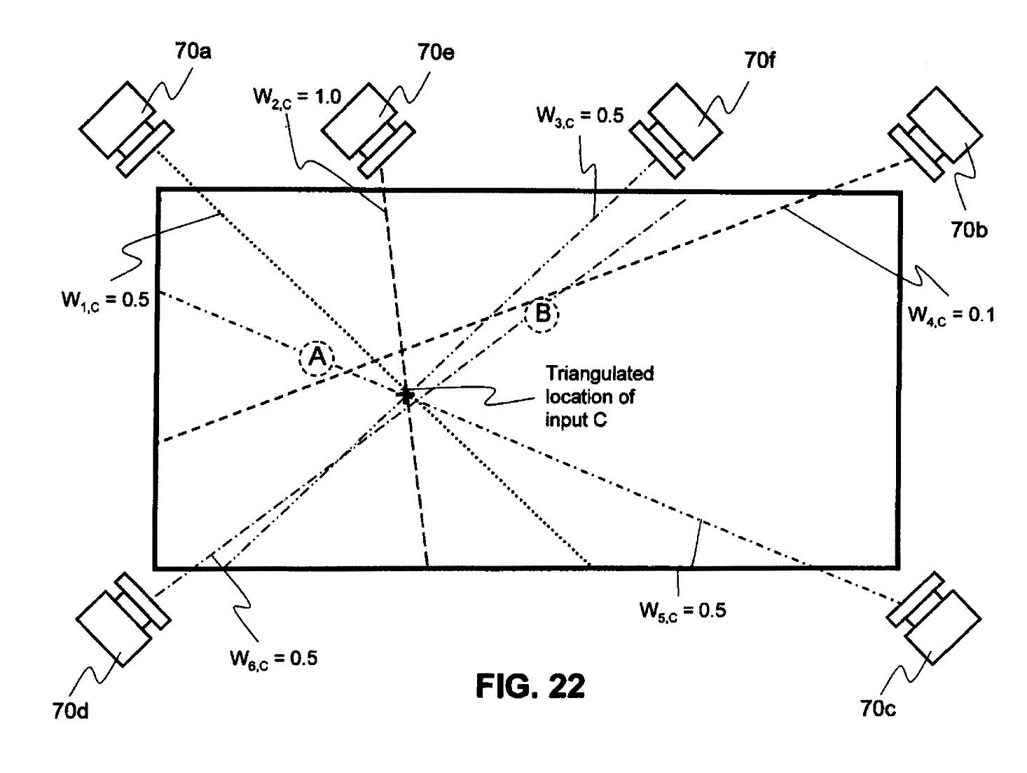

FIG. 22 shows the centerline and triangulated position for pointer C. It is clearly shown that the triangulated position was insignificantly influenced by the low weighted observation of imaging device 70b.

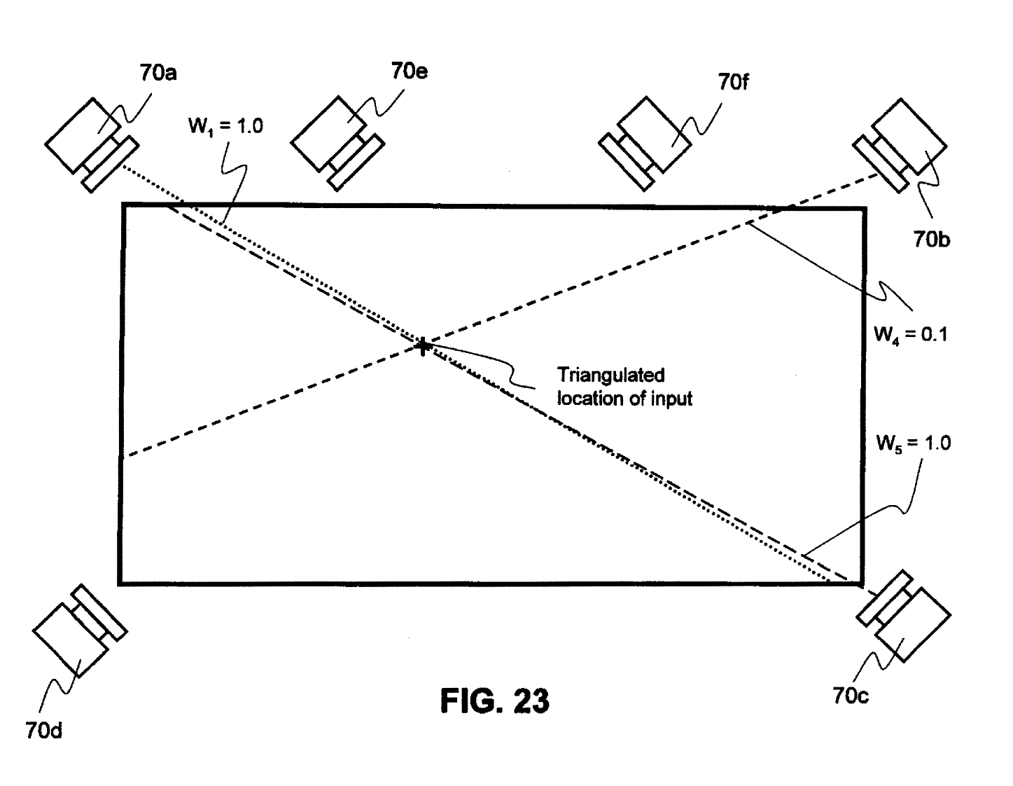

FIG. 23 shows an example of when a low weighted observation becomes important. In this scenario, the pointer is located almost directly between imaging devices 70a and 70c, which both have a clear view of the pointer and corresponding highly weighted observations. Imaging device 70b has a low weighted observation due to an ambiguity such as that situation presented in FIG. 19. The triangulation result from two imaging devices, in this case imaging devices 70a and 70c, triangulating a point directly or nearly directly between the two imaging devices is unreliable. In this case where one observation is lowly weighted, the observation is important because it provides an additional view of the target needed for triangulation. Even though the observation is low weighted, it is still better than no other observation at all.

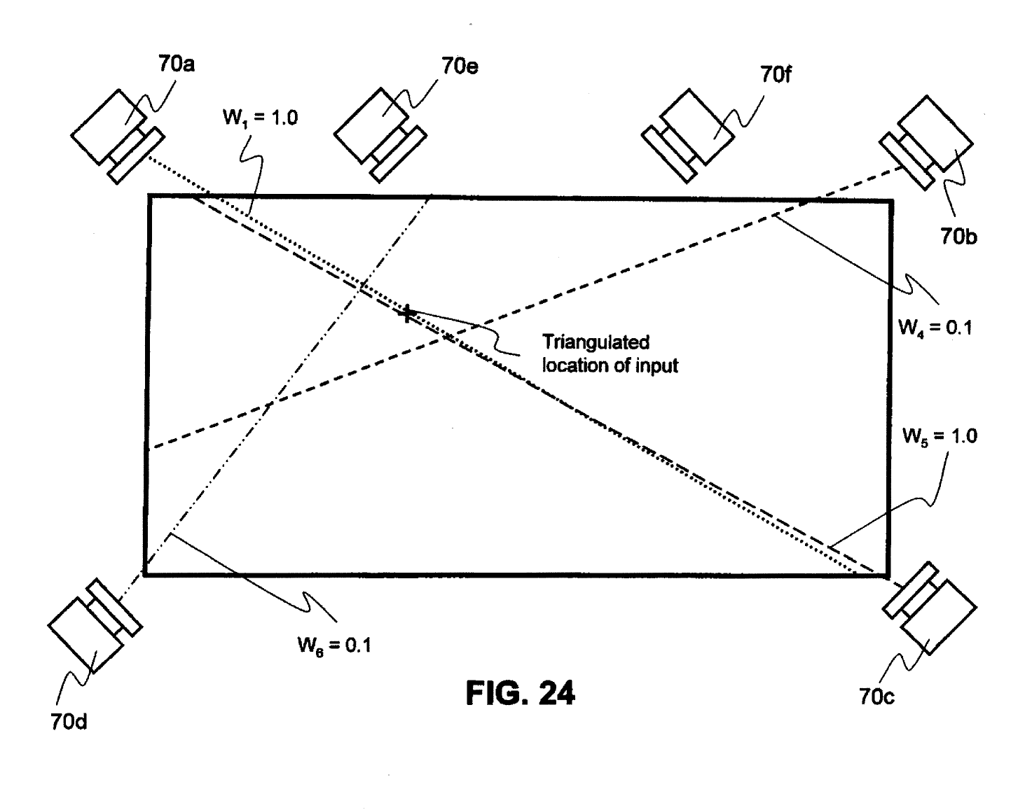

FIG. 24 depicts a similar scenario to that of FIG. 19 but has two imaging devices with low weighted observations (imaging devices 70b and 70d) and one imaging device with a high weighted observation (imaging device 70c). The observations from imaging devices 70b and 70d are averaged resulting in a triangulated point between the two observations and along the observation from imaging device 70c. In this case the triangulated location uses both low weighted observations to better locate the target.

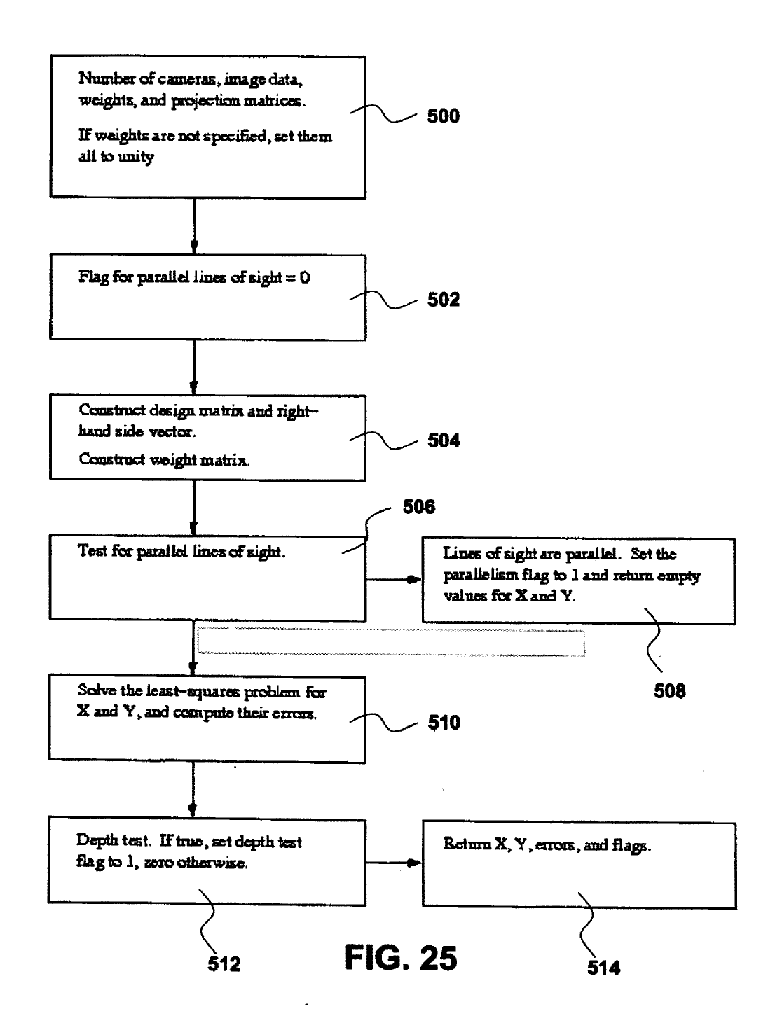

FIG. 25 shows the steps performed during triangulation of real and phantom targets. During triangulation, the number N of imaging devices being used to triangulate the (x,y) coordinates of a target, a vector x of length N containing image frame x-positions from each imaging device, a 2N×3 matrix Q containing the projection matrices P for each imaging device expressed as Q=[P₁|P₂| . . . |P_{N}]^{T}, where the superscript “T” represents a matrix transpose, and a vector w of length N containing the weights assigned to each observation in vector x are used (step 500). If weight for observations are not specified, the weights are set to a value of one (1). A binary flag for each parallel line of sight is then set to zero (0) (step 502). A tolerance for the parallel lines of sight is set to 2E, where E is the difference between 1 and the smallest exactly representable number greater than one. This tolerance gives an upper bound on the relative error due to rounding of floating point numbers and is hardware dependent. A least-squares design matrix A(N×2) and right-hand side vector b are constructed by looping over the N available imaging device views (step 504). During this process, a 2×3 matrix P is extracted for the current image frame. A row is added to the design matrix containing [P₁₁−x·P₂₁, P₁₂−x·P₂₂]. An element is added to side vector b containing [x·P₂₃−P₁₀]. An N×N diagonal matrix W containing the weights of vector w is then created. The determinant (typically constructed using the method outlined in http://mathwold.wolfram.com/determinant.html) of the weighted normal equations is computed and a check is made to determine whether or not it is less than the tolerance for parallelism according to det (W·A)^{T}·(W·A))≦2·ε (step 506). This test determines whether matrix A has linearly dependent rows. If the determinant is less than the tolerance, the parallelism flag is set to one (1) and the (x, y) coordinates are set to empty matrices (step 508). Otherwise, the linear least-squares problem for the (x, y) coordinates are solved according to (W A)^{T}(W A)X=(W A)^{T}b (step 510), where X=[X,Y]^{T} and b is also a two-element vector. The errors σₓ and σ_{y} for the (x,y) coordinates are computed from the square roots of the diagonal elements Cii of the covariance matrix C defined by C=σ²·((W·A)^{T}·(W·A))⁻¹, where σ₁ is the RMS error of the fit (i.e. the square root of chi-squared).

If N=2, no errors are computed as the problem is exactly determined. A check is then made to determine if the triangulated point is behind any of the imaging devices (step 512). Using the triangulated position, the expected target position for each imaging device is computed according to) x_{cal}=P·X, where x contains the image position x and the depth λ. The second element of x_{cal} is the depth λ from the imaging device to the triangulated point. If λ=0, the depth test flag is set to one (1) and zero (0) otherwise. If all components of x_{cal} are negative, the double negative case is ignored. The computed (x, y) coordinates, error values and test flags are then returned (step 514).

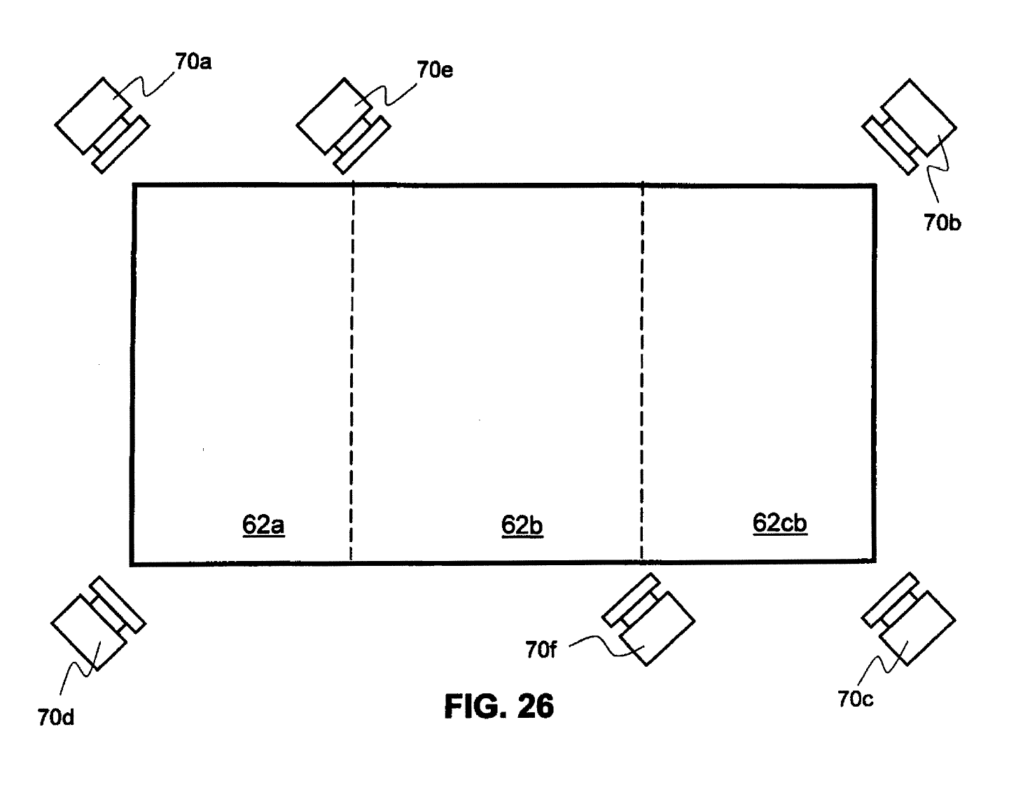

In the embodiment shown and described above, the interactive input system comprises six (6) imaging devices arranged about the input area 62 with four (4) imaging devices being positioned adjacent the corners of the input area and two imaging devices 70e and 70f being positioned at spaced locations along the same side of the input area. Those of skill in the art will appreciate that the configuration and/or number of imaging devices employed in the interactive input system may vary to suit the particular environment in which the interactive input system is to be employed. For example, the imaging devices 70e and 70f do not need to be positioned along the same side of the input area. Rather, as shown in FIG. 26, imaging device 70e can be positioned along one side of the input area 62 and imaging device 70f can be positioned along the opposite side of the input area 62.

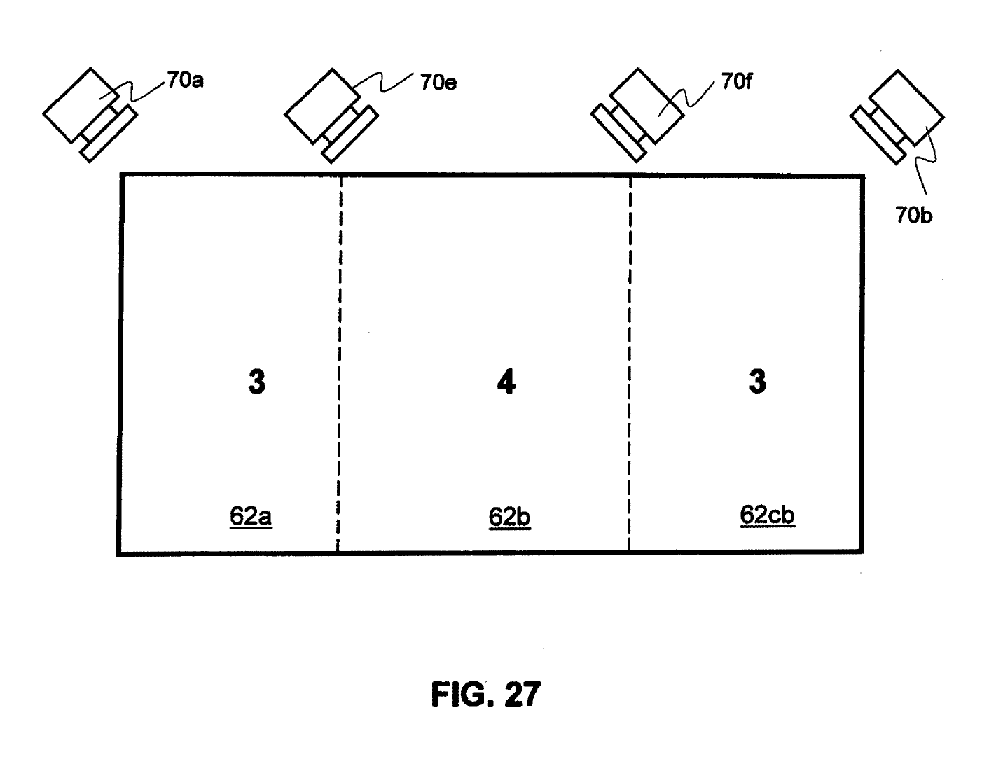

Turning now to FIG. 27, an alternative imaging device configuration for the interactive input system is shown. In this configuration, the interactive input system employs four (4) imaging devices 70a, 70e, 70f, and 70b arranged along one side of the input area 62. Imaging devices 70a, 70b are positioned adjacent opposite corners of the input area 62 and look generally across the entire input area 62. The intermediate imaging devices 70e, 70f are angled in opposite directions towards the center of the input area 62 so that the imaging devices 70a, 70e, 70f and 70b look generally across two-thirds of input area 62. This arrangement of imaging devices divides the input area 62 into three input regions, namely a left input region 62a, a central input region 62b and a right input region 62c as shown. The left input region 62a is within the fields of view of three (3) imaging devices, namely imaging devices 70a, 70e, and 70b. The right input region 62c is also within the fields of view of three (3) imaging devices, namely imaging devices 70a, 70f, and 70b. The central input region 62b is within the fields of view of all four (4) imaging devices 70a, 70e, 70f and 70b.

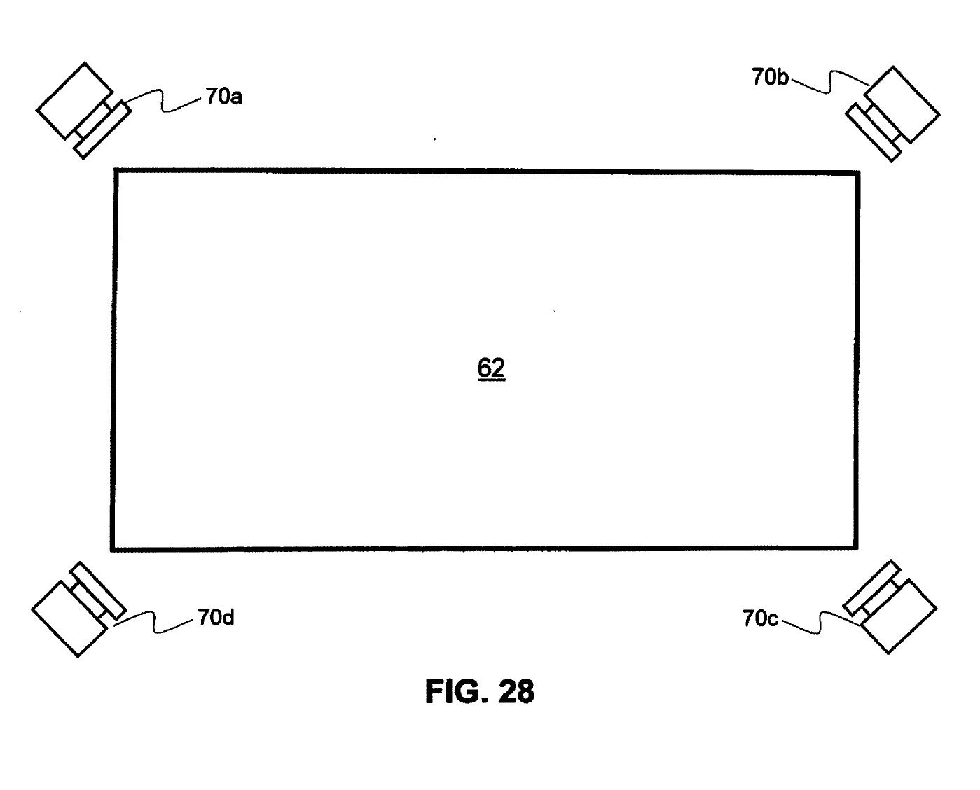

FIG. 28 shows another alternative imaging device configuration for the interactive input system. In this configuration, the interactive input system employs four (4) imaging devices 70a, 70b, 70c, 70d with each imaging device being positioned adjacent a different corner of the input area 62 and looking generally across the entire input area 62. With this imaging device arrangement, the entire input area 62 is within the fields of view of all four imaging devices.

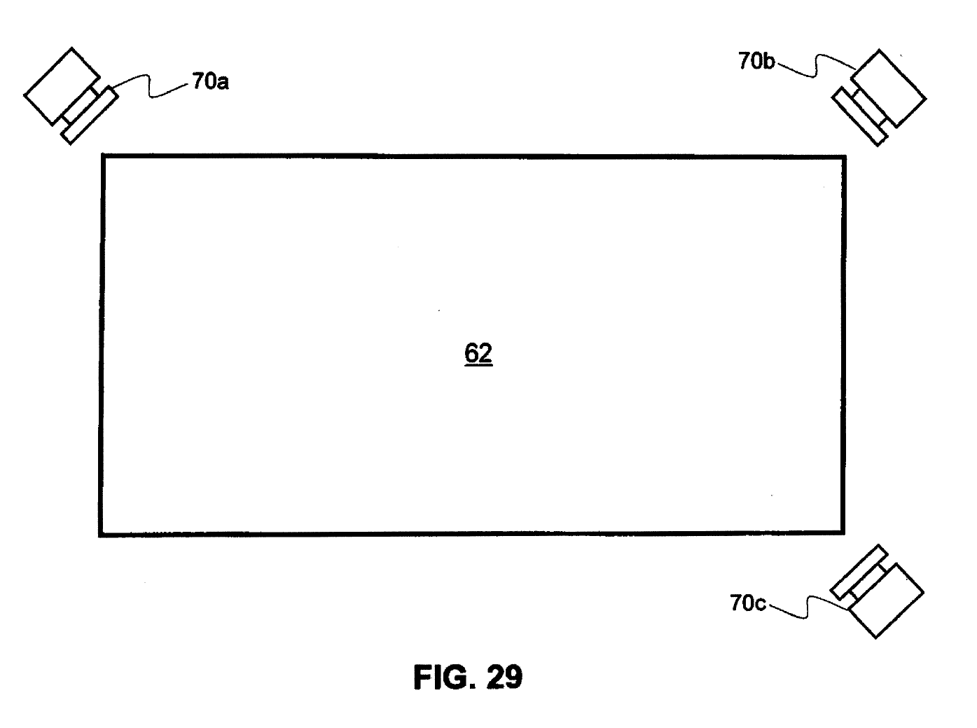

FIG. 29 shows yet another alternative imaging device configuration for the interactive input system. In this configuration, the interactive input system employs three (3) imaging devices 70a, 70b, 70c with each imaging device being positioned adjacent a different corner of the input area 62 and looking generally across the entire input area 62. With this imaging device arrangement, the entire input area is within the fields of view of all three imaging devices.

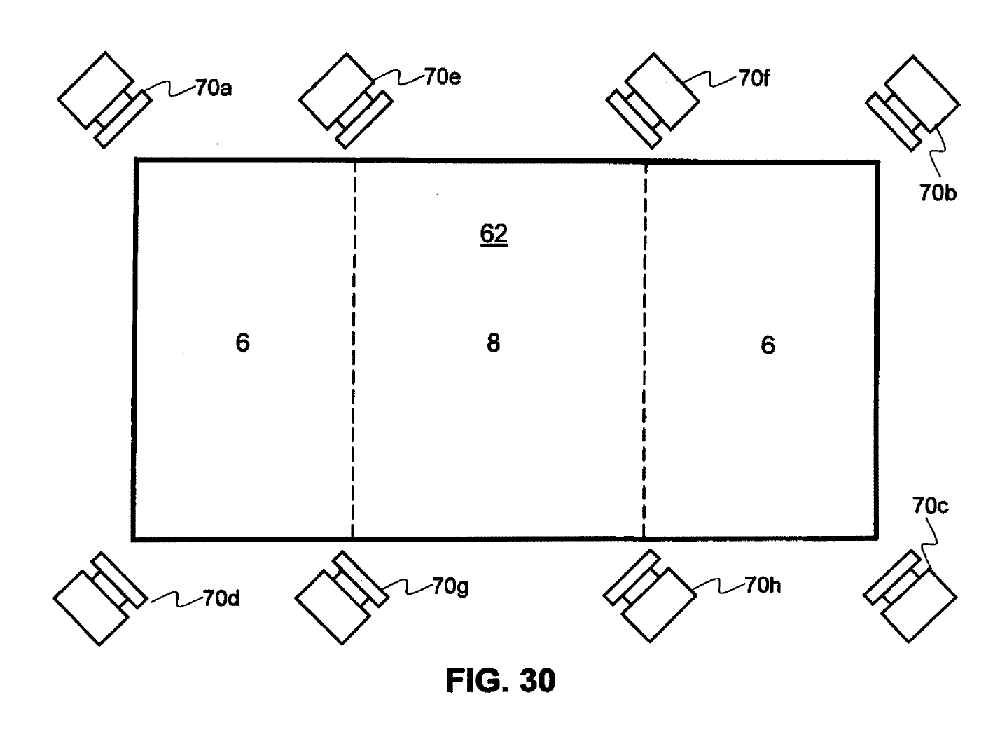

In FIG. 30, yet another alternative imaging device configuration for the interactive input system is shown. In this configuration, the interactive input system employs eight (8) imaging devices, with four imaging devices 70a, 70e, 70f, 70b being arranged along one major side of the input area 62 and with four imaging devices 70d, 70g, 70h, 70c being arranged along the opposite major side of the input area 62. Imaging devices 70a, 70b, 70c, 70d are positioned adjacent the corners of the input area and look generally across the entire input area 62. The intermediate imaging devices 70e, 70f, 70g, 70h along each major side of the input area are angled in opposite directions towards the center of the input area 62. This arrangement of imaging devices divides the input area into three (3) input regions. The number in each input region identifies the number of imaging devices whose fields of view see the input region.

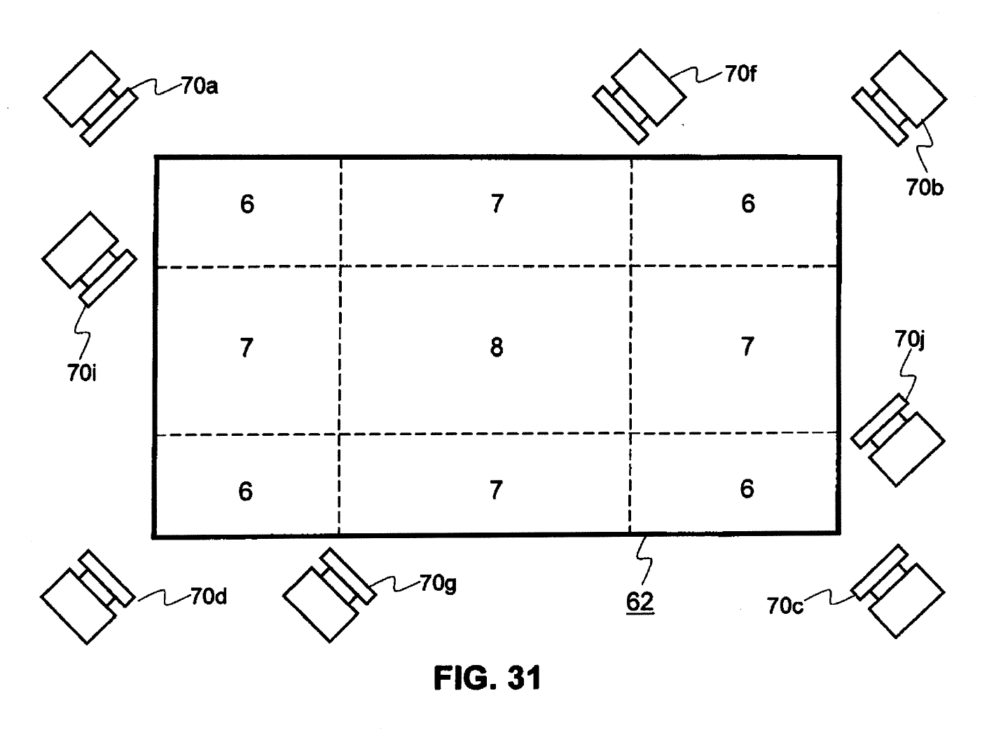

FIG. 31 shows yet another alternative imaging device configuration for the interactive input system. In this configuration, the interactive input system employs eight (8) imaging devices 70. Imaging devices 70a, 70b, 70c, 70d are positioned adjacent the corners of the input area 62 and look generally across the entire input area 62. Intermediate imaging devices 70f, 70g are positioned on opposite major sides of the input area and are angled in opposite directions towards the center of the input area 62. Intermediate imaging devices 70i, 70j are positioned on opposite minor sides of the input area 62 and are angled in opposite directions towards the center of the input area 62. This arrangement of imaging devices divides the input area into nine (9) input regions as shown. The number in each input region identifies the number of imaging devices whose fields of view see the input region.

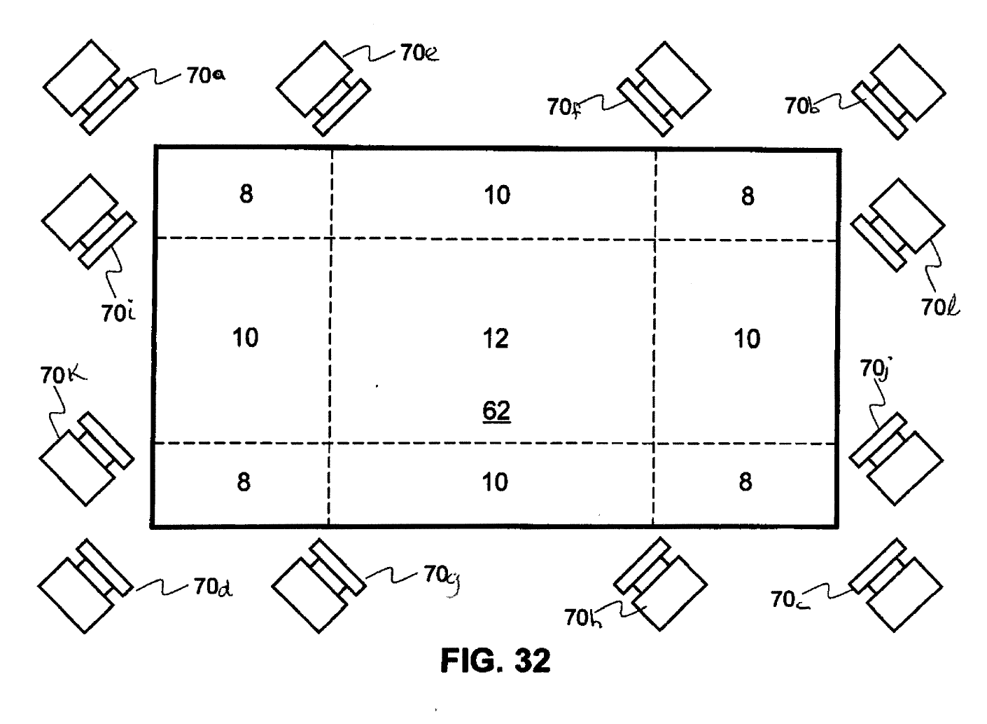

In FIG. 32, yet another alternative imaging device configuration for the interactive input system is shown. In this configuration, the interactive input system employs twelve (12) imaging devices. Imaging devices 70a, 70b, 70c, 70d are positioned adjacent the corners of the input area 62 and look generally across the entire input area 62. Pairs of intermediate imaging devices 70e and 70f, 70g and 70h, 70i and 70k, 70j and 70l are positioned along each side of the input area and are angled in opposite directions towards the center of the input area 62. This arrangement of imaging devices divides the input area 62 into nine (9) input regions as shown. The number in each input region identifies the number of imaging devices whose fields of view see the input region.

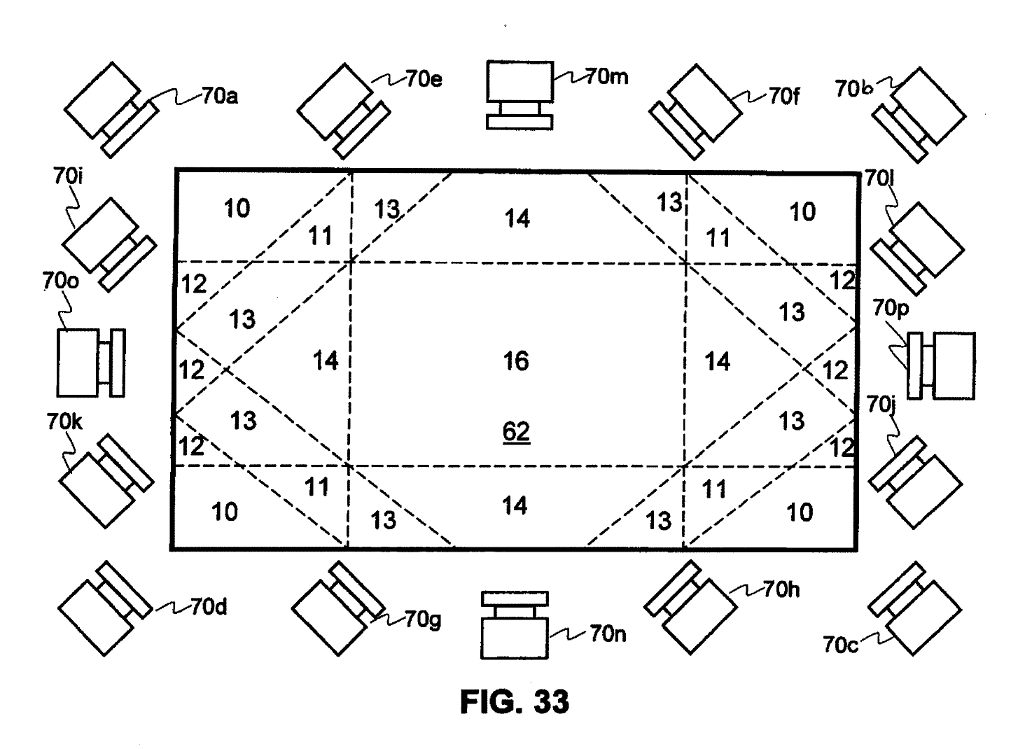

FIG. 33 shows yet another alternative imaging device configuration for the interactive input system. In this configuration, the interactive input system employs sixteen (16) imaging devices 70. Imaging devices 70a, 70b, 70c, 70d are positioned adjacent the corners of the input area and look generally across the entire input area 62. Pairs of intermediate imaging devices 70e and 70f, 70g and 70h, 70i and 70k, 70j and 70l are positioned along each side of the input area and are angled in opposite directions towards the center of the input area 62. Four midpoint imaging devices 70m, 70n, 70o, 70p are positioned at the midpoint of each side of the input area 62 and generally look across the center of the input area 62. This arrangement of imaging devices 70 divides the input area 62 into twenty-seven (27) input regions as shown. The number in each input region identifies the number of imaging devices whose fields of view see the input region.

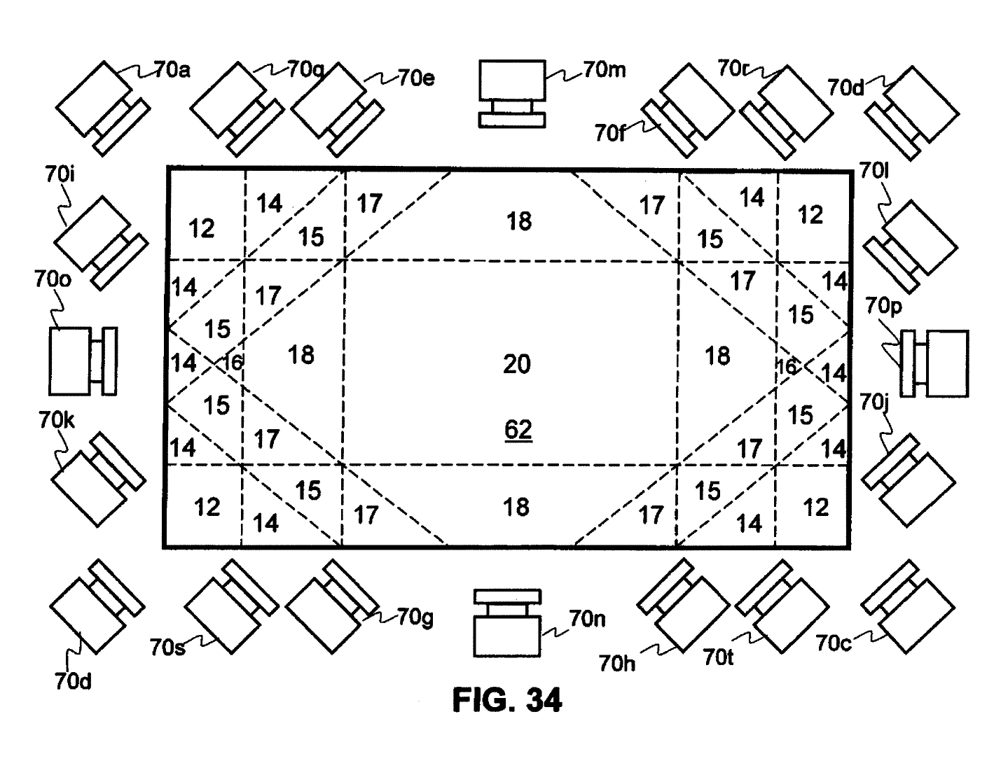

FIG. 34 shows yet another alternative imaging device configuration for the interactive input system. In this configuration, the interactive input system employs twenty (20) imaging devices 70. Imaging devices 70a, 70b, 70c, 70d are positioned adjacent the corners of the input area and look generally across the entire input area 62. Pairs of intermediate imaging devices 70e and 70f, 70g and 70h, 70i and 70k, 70j and 70l are positioned along each side of the input area and are angled in opposite directions towards the center of the input area 62. Two further intermediate imaging devices 70q, 70r, 70s, 70t are positioned along each major side of the input area 62 and are angled in opposite directions towards the center of the input area 62. Four midpoint imaging devices 70m, 70n, 70o, 70p are positioned at the midpoint of each side of the input area 62 and generally look across the center of the input area 62. This arrangement of imaging devices divides the input area into thirty-seven (37) input regions as shown. The number in each input region identifies the number of imaging devices whose fields of view see the input region.

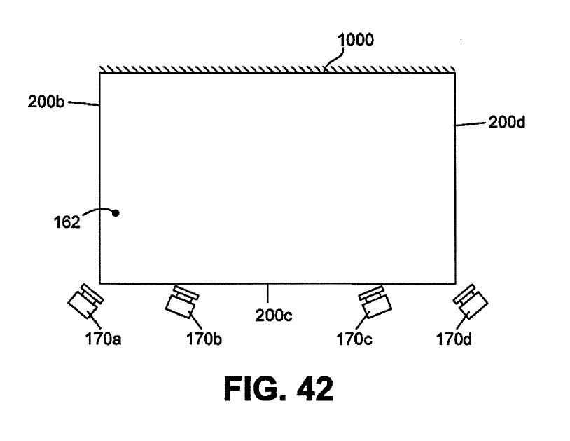

FIG. 42 shows yet another alternative imaging device and illuminated bezel configuration for the interactive input system. In this configuration, the illuminated bezel 72 comprises three bezel segments 200b, 200c and 200d, each extending substantially along the entire length of a respective side of an input area 162. Bezel segments 200b and 200d extend along opposite minor side edges of the input area 162, whereas bezel segment 200c extends along one major side edge of the input area 162. A reflective surface, in this case a mirror 1000, extends along the other major side edge of the input area 162, opposite bezel segment 200c, and is configured to face the input area 162. Mirror 1000 serves to provide reflections of the bezel segments 200b, 200c and 200d, and any pointers positioned within the input area 162, to facilitate touch detection as will be described. To take best advantage of the reflective properties of mirror 1000, the mirror is oriented so that its inwardly facing reflective surface in a plane generally normal to the plane of the display surface of display panel 60.

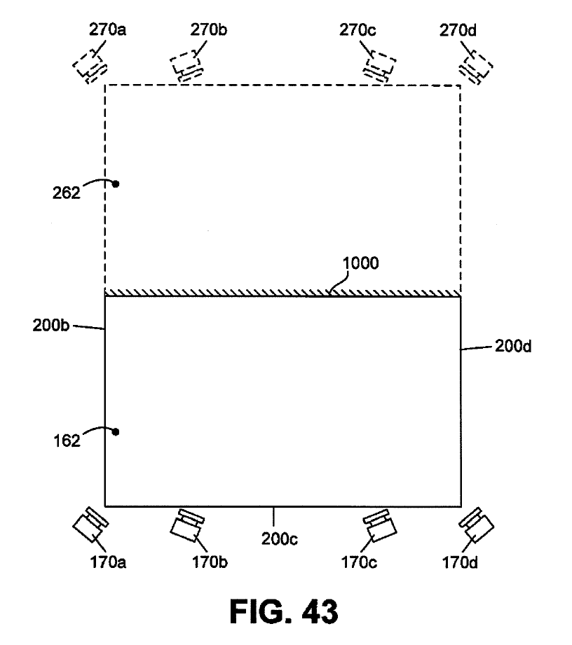

In this embodiment, the interactive input system employs four (4) imaging devices 170a to 170d arranged at spaced locations along the same major side edge of the input area 162 as bezel segment 200c. Imaging devices 170a and 170d are positioned adjacent the corners of the bezel segment 200c and look generally across the entire input area 162 towards the center of the mirror 1000. Imaging devices 170b and 170c are positioned intermediate the imaging devices 170a and 170d, and are angled in opposite directions towards the center of the mirror 1000. The utilization of mirror 1000 effectively creates an interactive input system employing eight (8) imaging devices that is twice as large. In particular, the reflection produced by mirror 1000 effecting creates four (4) virtual imaging devices 270a to 270d, each corresponding to a reflected view of the four (4) imaging devices 170a to 170d, as shown in FIG. 43. Consequently, the reflection of the input area 162 in the mirror 1000 forms a virtual input area 262, and thus the interactive input system effectively employs eight (8) imaging devices, having three (3) input regions, similar to the embodiment described above with reference to FIG. 30.

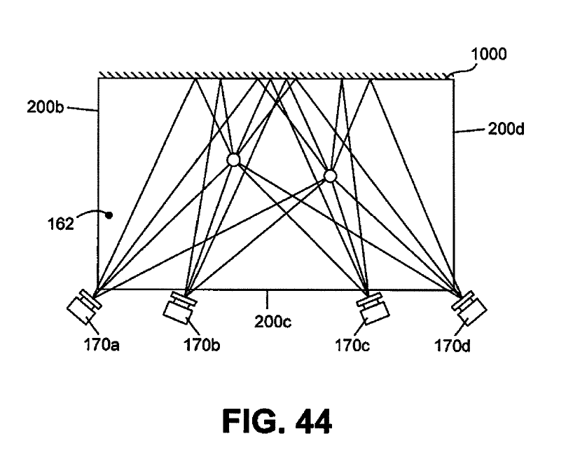

FIG. 44 shows the interactive input system in the situation where two pointers are positioned within the input area 162. As can be seen, mirror 1000 produces a reflection of each pointer such that each of the imaging devices 170a to 170d captures image frames including up to two observations of each pointer, one of which corresponds to a real pointer image, and the other of which corresponds to a virtual pointer image, that is, a view of the pointer as reflected off of mirror 1000. Generally, the aforementioned method described with reference to FIG. 13 is unable to handle reflections of pointers to resolve pointer ambiguity. This is resolved by reformatting the image frame data, as will be discussed.

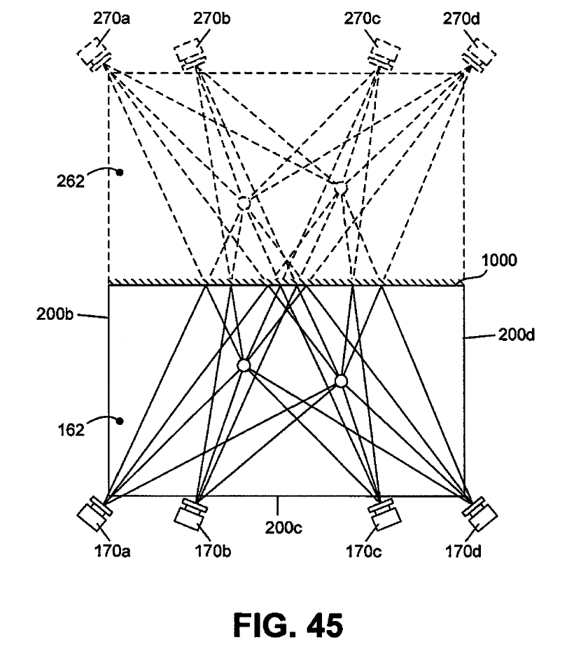

FIG. 45 also shows the two pointers are positioned within the input area 162 as well as virtual pointers in the virtual input area. As can be seen, each imaging device 170a to 170d has a corresponding virtual imaging device 270a to 270d. Each pointer within the input surface 162 is reflected by the mirror 1000. The addition of mirror 1000 to the four (4) imaging device interactive input system with two pointers (FIG. 44) creates an equivalent eight (8) imaging device interactive input system with four pointers (FIG. 45). Treating the interactive input system as this equivalent allows the pointer data to be processed using the aforementioned method, similar to that of FIG. 30. The only modification required is that any pointer deemed to be positioned within the input area 162 at a location above the mirror 1000 (that is, within virtual input area 262) is discarded, since anything positioned above mirror 1000 must be a reflection.

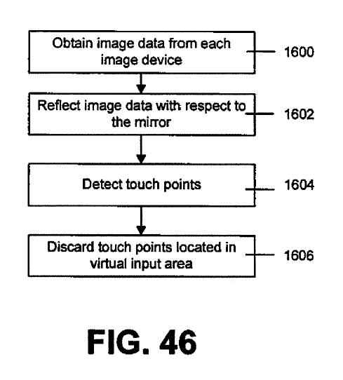

In particular, as shown in FIG. 46 image data for each imaging device as described above (step 1600) is reflected to yield observations representing each of the virtual pointer images (step 1602). The method as described with reference to FIG. 30 is then used to detect the location of the targets (step 1604). Any target that is determined to be located within the virtual input area 262 is discarded (step 1606), and any target determined to be located within the input area 162 is reported to the general purpose computing device 140 for further processing (e.g., triggering commands to the general purpose computing device, updating screen images, etc.).

Although the above interactive input system utilizes four imaging devices in combination with a single mirror, those of skill in the art will appreciate that alternatives are available. For example, more or fewer imaging devices may be provided and oriented around the perimeter of the input area, in combination with one or more mirrors oriented to provide reflections of the bezel segments and thus reflections of any pointers brought into proximity of the input area.

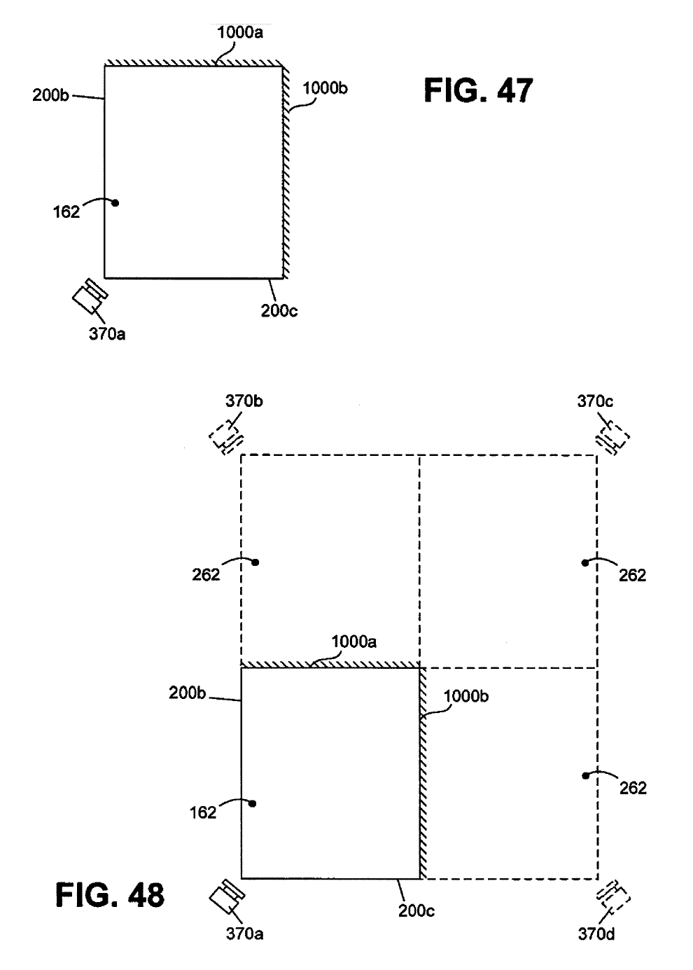

FIG. 47 shows an embodiment of an interactive input system utilizing a single imaging device 370a. In this embodiment, the illuminated bezel 72 comprises two bezel segments 200b and 200c extending along two adjacent side edges of the input area 162. A pair of mirrors 1000a and 1000b extend along the other two side edges of the input area 162, and are configured to face the input area 162. Mirrors 1000a and 1000b serve to provide reflections of the bezel segments 200b and 200c, and any pointers positioned within the input area 162. Imaging device 370a is positioned at corner of the input area 162, adjacent the intersection of bezel segments 200b and 200c. Imaging device 370a looks generally across the entire input area 162, towards the corner at which mirrors 1000a and 1000b intersect. The utilization of mirrors 1000a and 1000b effectively creates an interactive input system employing four (4) imaging devices 370a to 370d that is four times as large, as shown in FIG. 48. In particular, the reflections produced by mirrors 1000a and 1000b effectively creates three (3) virtual imaging devices 370b to 370d, each corresponding to a reflected view of the imaging device 370a. Consequently, the reflections of the input area 162 form a virtual input area 262, and thus the interactive input system effectively employs four (4) imaging devices, similar to the embodiment described above with reference to FIG. 28. Utilizing the method of FIG. 46, any pointer realized to be within the virtual input area 262 is discarded.

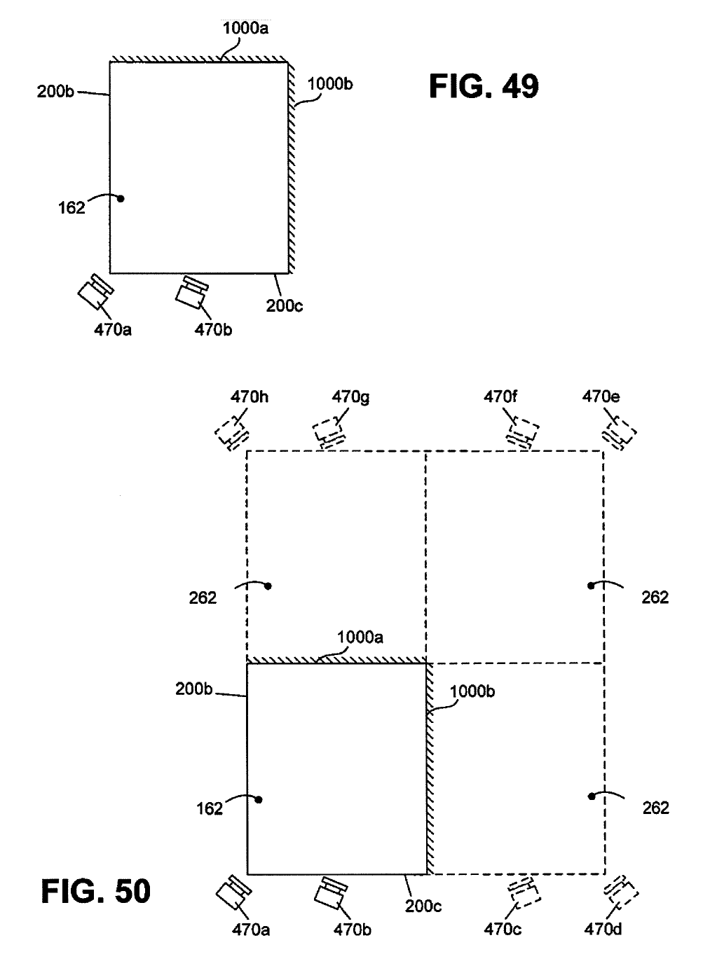

FIG. 49 shows an embodiment of an interactive input system similar to the embodiment of FIG. 47 utilizing two (2) imaging devices 470a and 470b positioned adjacent the corner at which the two bezel segments 200b and 200c intersect. The imaging devices 470a and 470b look generally across the entire input area 162, towards the corner adjacent mirrors 1000a and 1000b. The utilization of mirrors 1000a and 1000b effectively creates an interactive input system employing eight (8) imaging devices 470a to 470h that is four times as large, as shown in FIG. 50. In particular, the reflections produced by mirrors 1000a and 1000b effectively creates six (6) virtual imaging devices 470c to 470h, each corresponding to a reflected view of one of the imaging devices 470a and 470b.

Although exemplary imaging device and mirror configurations are shown in FIGS. 42 to 49, one skilled in the art will appreciate that alternative imaging device and mirror configurations are readily available. For example, imaging devices may be positioned adjacent the midpoints the bezel segments, and configured to look generally across the input area.

Although the interactive input systems are described as comprising an LCD or plasma display panel, those of skill in the art will appreciate that other display panels such as for example flat panel display devices, light emitting diode (LED) panels, cathrode ray tube (CRT) devices etc. may be employed. Alternatively, the interactive input system may comprise a display surface on which an image projected by a projector within or exterior of the housing is employed.

In the embodiments described above, the imaging devices comprise CMOS image sensors configured for a pixel sub-array. Those of skill in the art will appreciate that the imaging devices may employ alternative image sensors such as for example, line scan sensors to capture image data.

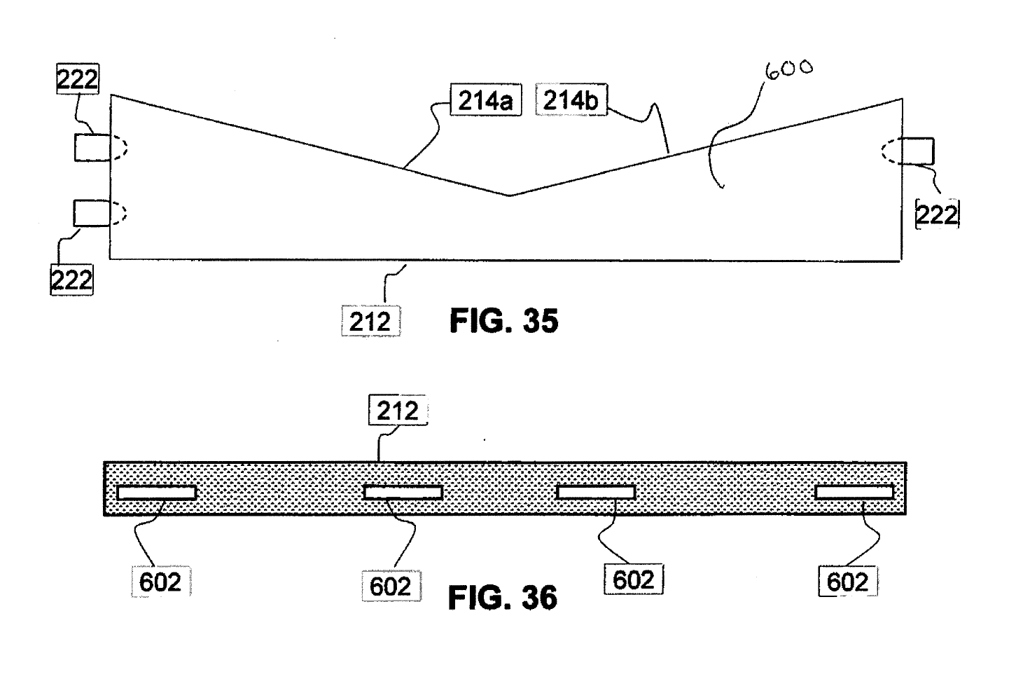

Although particular embodiments of the bezel segments have been described above, those of skill in the art will appreciate that many alternatives are available. For example, more or fewer IR LEDs may be provided in one or more of the bezel surfaces. For example, FIG. 35 shows an embodiment of the bezel segment generally identified by numeral 600 where one side surface accommodates a pair of IR LEDs 222a, 222b and the opposite side surface accommodates a single IR LED 222c. If desired, rather than providing notches in the undersurface of the bezel segments, recesses 602 may be provided in the body of the bezel segments to accommodate the imaging devices as shown in FIG. 36. Of course a combination of notches and recesses may be employed.

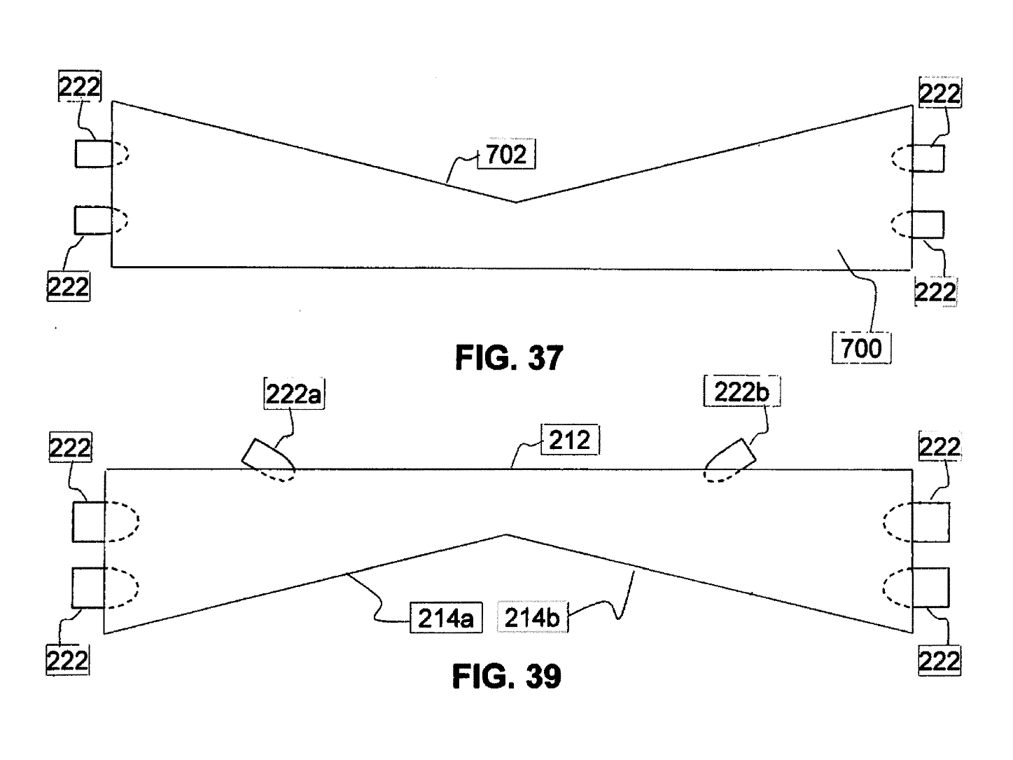

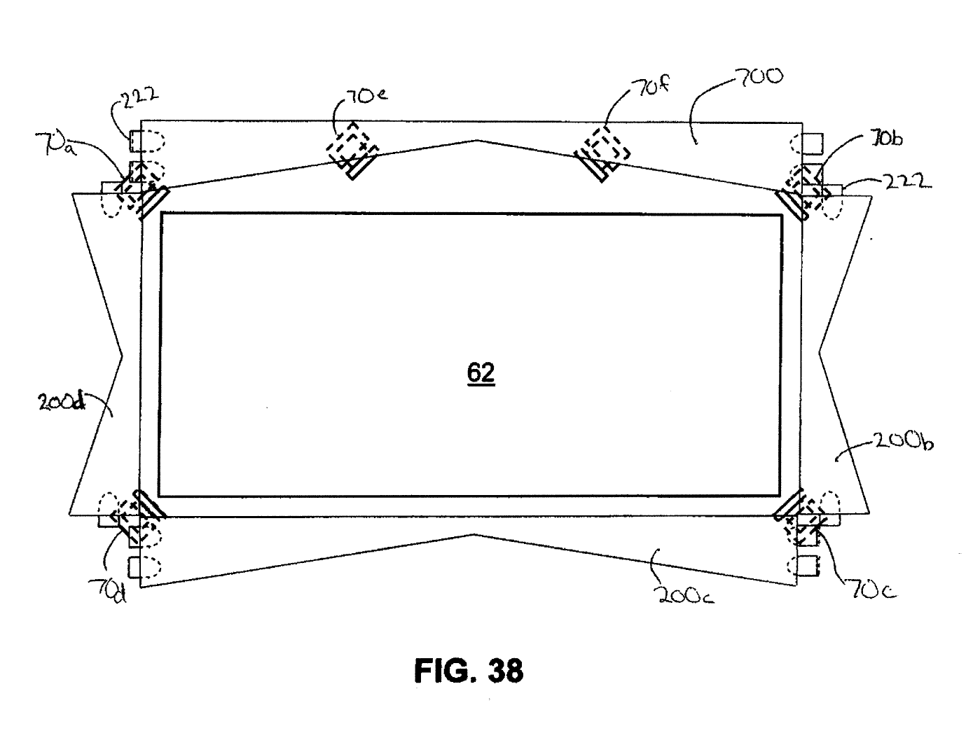

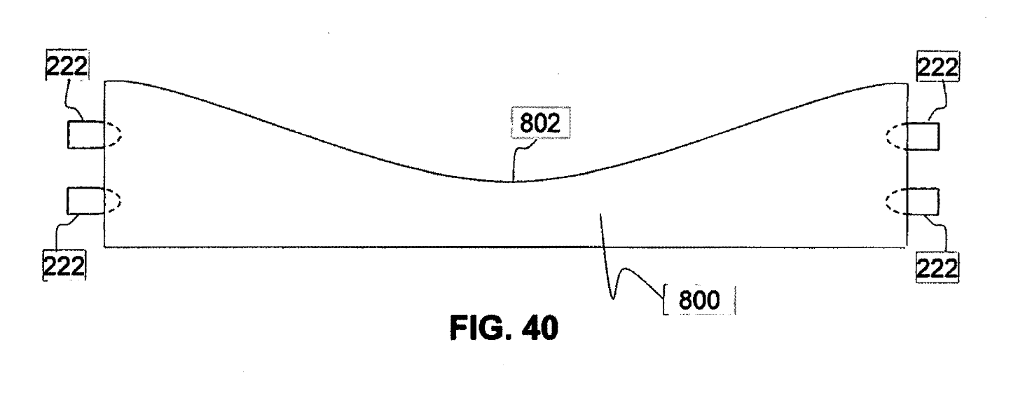

In the above embodiments, each bezel segment has a planar front surface and a v-shaped back reflective surface. If desired, the configuration of one or more of the bezel segments can be reversed as shown in FIG. 37 so that the bezel segment 700 comprises a planar reflective back surface 204 and a v-shaped front surface 702. Optionally, the v-shaped front surface could be diffusive. Alternatively, the v-shaped back surface could be diffusive and the planar front surface could be transparent. In a further alternative embodiment, instead of using a v-shaped back reflective surface, the bezel segments 800 may employ a parabolic-shaped back reflective surface 802 as shown in FIG. 40 or other suitably shaped back reflective surface. FIG. 38 shows the interactive input system employing an illuminated bezel formed of a combination of bezel segments. In particular, bezel segment 700 is of the type shown in FIG. 37 while bezel segments 200b to 200d are of the type shown in FIGS. 1 to 6. If desired, supplementary IR LEDs 222a, 222b may be accommodated by bores formed in the planar reflective back surface as shown in FIG. 39. In this case, the supplementary IR LEDs 222a, 222b are angled towards the center of the bezel segment.

Although embodiments of bezel segment front surface diffusion patterns are shown and described, other diffusion patterns can be employed by applying lenses, a film, paint, paper or other material to the front surface of the bezel segments to achieve the desired result. Also, rather than including notches to accommodate the imaging devices, the bezel segments may include slots or other suitably shaped formations to accommodate the imaging devices.

In the embodiments shown and described above, the interactive input system is in the form of a table. Those of skill in the art will appreciate that the interactive input system may take other forms and orientations.

Although embodiments of the interactive input system have been shown and described above, those of skill in the art will appreciate that further variations and modifications may be made without departing from the spirit and scope thereof as defined by the appended claims.

What is claimed is:

1. A method of resolving ambiguities between at least two pointers within a region of interest comprising:
capturing images of the region of interest and at least one reflection thereof from different vantages using a plurality of imaging devices;
processing image data to identify a plurality of targets for the at least two pointers;
for each image, determining a state for each target and assigning a weight to the image data based on the state; and
calculating a pointer location for each of the at least two pointers based on the weighted image data.

2. The method of claim 1, wherein the calculating is performed using weighted triangulation.

3. The method of claim 2 further comprising determining real and phantom targets associated with each pointer.

4. The method of claim 3 wherein a high weight is assigned to the image data from an unobstructed image and a low weight is assigned to the image data from an obstructed image.

5. The method of claim 1 comprising:
determining if any of the targets are located within a virtual input area, and discarding the targets located within the virtual input area.

6. An interactive input system comprising:
an input surface divided into at least two input areas;
at least one mirror positioned with respect to the input surface and producing a reflection thereof, thereby defining at least two virtual input areas;
a plurality of imaging devices having at least partially overlapping fields of view, the imaging devices being oriented so that different sets of imaging devices image the input area and virtual input areas; and
processing structure processing image data acquired by the imaging devices to track the position of at least two pointers adjacent the input surface and resolving ambiguities between the pointers.

7. The interactive input system of claim 6, wherein the processing structure comprises a candidate generation procedure module to determine for each input area and virtual input area if consistent candidates exist in image frames captured by the respective set of imaging devices.

8. The interactive input system of claim 7, wherein the processing structure further comprises an association procedure module to associate the consistent candidates with targets associated with the at least two pointers.

9. The interactive input system of claim 8, wherein the processing structure further comprises a tracking procedure module to track the targets in the at least two input regions.

10. The interactive input system of claim 9, wherein the processing structure further comprises a state estimation module to determine locations of the at least two pointers based on information from the association procedure module and the tracking procedure module and image data from the plurality of imaging devices.

11. The interactive input system of claim 10, wherein the processing structure further comprises a disentanglement process module to, when the at least two pointers appear merged, determine locations for each of the pointers based on information from the state estimation module, the tracking procedure module and image data from the plurality of imaging devices.

12. The interactive input system of claim 11, wherein weights are assigned to the image data from each of the plurality of imaging devices.

13. The interactive input system of claim 12, wherein the processing structure uses weighted triangulation for processing the image data.

14. The interactive input system of claim 13, wherein weights are assigned to the image data from each of the plurality of imaging devices.

15. An interactive input system comprising:
a plurality of imaging devices having fields of view encompassing an input area and a virtual input area, the imaging devices being oriented so that different sets of imaging devices image different input regions of the input area and the virtual input area.

16. The interactive input system of claim 15, wherein at least one of the input regions is imaged by all of the imaging devices and wherein at least another of the input regions is imaged by a subset of the imaging devices.

17. The interactive input system of claim 16, wherein at least one of the input regions is viewed by at least three imaging devices.

18. The interactive input system of claim 17, wherein at least three input regions of the input area and the virtual input area are imaged, a central region being imaged by all of the imaging devices and regions on opposite sides of the central region being imaged by different subsets of imaging devices.

19. The interactive input system of claim 15 wherein the plurality of imaging devices comprises at least one real imaging device and at least one virtual imaging device.
